(19) United States
(12) Patent Application Publication
(10) Pub. No.: US 2026/0338130 A1
(43) Pub. Date: Oct. 29, 2026

(54) INTERNAL COMBUSTION ENGINE CONTROL DEVICE AND INTERNAL COMBUSTION ENGINE CONTROL METHOD

(71) Applicant: Hitachi Astemo, Ltd., Hitachinaka-shi, Ibaraki (JP)

(72) Inventors: Eiichiro OHATA, Hitachinaka-shi, Ibaraki (JP); Kunihiko SUZUKI, Hitachinaka-shi, Ibaraki (JP)

(73) Assignee: Hitachi Astemo, Ltd., Hitachinaka-shi, Ibaraki (JP)

(21) Appl. No.: 19/103,660

(22) PCT Filed: Nov. 24, 2022
(86) PCT No.: PCT/JP2022/043273

§ 371 Date: Feb. 13, 2025

(51) Int. Cl. F02D 43/00; F02D 41/38; F02P 5/15

(52) U.S. Cl. CPC F02D 43/00; F02D 41/38; F02P 5/1502; F02D 2200/101

(57) ABSTRACT

An object is to appropriately control a heat balance of an ignition device to suppress an increase in size and cost of the ignition device. An internal combustion engine control device controls an internal combustion engine in which a current flowing through an ignition coil of an ignition device is interrupted according to a predetermined ignition timing. The internal combustion engine control device includes a request setting unit, an adjustment unit, and an ignition control unit. The request setting unit determines a request energization amount of the ignition coil on the basis of the rotation speed of the internal combustion engine. The adjustment unit adjusts an energization amount of the ignition coil according to a temperature related to the ignition device and a request energization amount. The ignition control unit controls an interruption state of the ignition coil according to the energization amount of the ignition coil adjusted by the adjustment unit.

### TECHNICAL FIELD

The present invention relates to an internal combustion engine control device and an internal combustion engine control method.

### BACKGROUND ART

In recent years, in order to improve the fuel consumption of a vehicle, a lean combustion technique in which an air-fuel mixture larger than a theoretical air-fuel ratio (fuel is thinner) is combusted to operate an internal combustion engine, and an exhaust gas recirculation technique in which a part of the exhaust gas after combustion is taken in and sucked again have been developed.

In this type of internal combustion engine, sparks are less likely to be blown to the ignition plug due to the use of an air-fuel mixture with thin fuel and the implementation of exhaust gas recirculation. Therefore, the ignition capability (that is, the ignition energy amount) of the ignition device required for flame formation in the combustion chamber is increased as compared with the case of igniting the air-fuel mixture of the theoretical air-fuel ratio. Therefore, the amount of heat of the ignition coil per unit time increases.

For example, PTL 1 discloses an ignition device of an engine configured to correct ignition energy in accordance with a change in pressure in an intake pipe. The ignition device for an engine disclosed in PTL 1 increases ignition energy by extending an energization time of an ignition coil on the basis of an intake pipe pressure Pm so as not to cause misfire during supercharging. As a result, a stable combustion state is secured even in a situation where it is difficult for sparks to fly to the ignition plug due to supercharging.

### CITATION LIST

### Patent Literature

PTL 1: JP 2000-054941 A

### SUMMARY OF INVENTION

### Technical Problem

However, the ignition device of the engine disclosed in PTL 1 does not consider the heat balance of the ignition coil. For example, when the internal combustion engine is operated at a high load and continuously in a state where the pressure Pm of the intake pipe is increased by supercharging, the energization time to the ignition coil is extended. As a result, the ignition device maintains a situation in which the ignition energy is increased, that is, a situation in which the amount of heat per unit time is large. As a result, the temperature of the ignition device may exceed the preset rated temperature.

As a countermeasure against such a problem, it is conceivable to design heat dissipation of the ignition coil in consideration of the maximum condition of the amount of heat per unit time of the ignition coil in the duration of the high-load continuous operation or the like and severe environmental conditions such as a case where the outside temperature is high in summer. However, this measure causes new problems such as an increase in size and cost of the ignition device.

In view of the above problems, an object of the present invention is to provide an internal combustion engine control device and an internal combustion engine control method that appropriately control a heat balance of an ignition device and suppress an increase in size and cost of the ignition device.

### Solution to Problem

In order to solve the above problems and achieve the present object, an internal combustion engine control device according to an aspect of the present invention controls an internal combustion engine in which a current flowing through an ignition coil of an ignition device is interrupted according to a predetermined ignition timing. The internal combustion engine control device includes a request setting unit, an adjustment unit, and an ignition control unit. The request setting unit determines a request energization amount of the ignition coil on the basis of the rotation speed of the internal combustion engine. The adjustment unit adjusts an energization amount of the ignition coil according to a temperature related to the ignition device and a request energization amount. The ignition control unit controls an interruption state of the ignition coil according to the energization amount of the ignition coil adjusted by the adjustment unit.

An internal combustion engine control method according to an aspect of the present invention is a method of controlling an internal combustion engine in which a current flowing through an ignition coil of an ignition device is interrupted according to a predetermined ignition timing. In this internal combustion engine control method, the request setting unit determines a request energization amount of the ignition coil on the basis of the rotation speed of the internal combustion engine. Next, the adjustment unit adjusts an energization amount of the ignition coil according to a temperature related to the ignition device and a request energization amount. Then, the ignition control unit controls an interruption state of the ignition coil according to the energization amount of the ignition coil adjusted by the adjustment unit.

### Advantageous Effects of Invention

According to one aspect of the present invention, it is possible to appropriately control the heat balance of the ignition device in the internal combustion engine, and to suppress an increase in size and cost of the ignition device. Note that problems, configurations, and effects other than those described above will be clarified by the following description of the embodiments.

### BRIEF DESCRIPTION OF DRAWINGS

FIG. 1 is an overall configuration diagram illustrating a basic configuration example of an internal combustion engine according to an embodiment.

FIG. 2 is a partially enlarged view illustrating an ignition plug according to the embodiment.

FIG. 3 is a functional block diagram illustrating a functional configuration of an internal combustion engine control device according to the embodiment.

FIG. 4 is a circuit diagram illustrating an example of an electrical circuit including an ignition coil.

FIG. 5 is a diagram for explaining a relationship between a temperature of an electrode, minimum ignition energy, and an air-fuel ratio.

FIG. 6 is an example of a discharge waveform of multiple ignition.

FIG. 7 is a conceptual diagram illustrating the relationship between suppliable discharge energy, request discharge energy, and the difference thereof with respect to the temperature of the ignition coil.

FIG. 8 is a conceptual diagram illustrating a relationship between a temperature and discharge energy of a conventional ignition coil.

FIG. 9 is a conceptual diagram illustrating a relationship between a temperature of an ignition coil and discharge energy in a case where the present invention is applied.

FIG. 10 is a flowchart illustrating ignition and fuel injection control processing according to a first embodiment.

FIG. 11 is a conceptual diagram illustrating weights and biases of neurons constituting a neural network model.

FIG. 12 is a diagram for explaining a method of realizing operation of each objective variable by the neural network model according to the first embodiment.

FIG. 13 is a conceptual diagram illustrating a neural network model used for ignition and fuel injection control processing according to the first embodiment.

FIG. 14 is a correspondence table illustrating a relationship between an objective variable and an explanatory variable in a case where the neural network model according to the first embodiment is used.

FIG. 15 is a selection table of influence factors when selecting explanatory variables for estimating an ignition coil temperature according to the first embodiment.

FIG. 16 is a diagram for explaining a limit dwell map according to a second embodiment.

FIG. 17 is a diagram for explaining a request dwell map according to the second embodiment.

FIG. 18 is a diagram for explaining a voltage correction coefficient map according to the second embodiment.

FIG. 19 is a flowchart illustrating ignition and fuel injection control processing according to the second embodiment.

FIG. 20 is a diagram for explaining a temperature correction coefficient map according to a third embodiment.

FIG. 21 is a flowchart illustrating ignition and fuel injection control processing according to the third embodiment.

FIG. 22 is a diagram for explaining a low-temperature request dwell map according to a fourth embodiment.

FIG. 23 is a diagram for explaining a high-temperature request dwell map according to the fourth embodiment.

FIG. 24 is a flowchart illustrating ignition and fuel injection control processing according to the fourth embodiment.

FIG. 25 is a circuit diagram illustrating an example of an electrical circuit including a fire coil according to a fifth embodiment.

### DESCRIPTION OF EMBODIMENTS

### First Embodiment

Hereinafter, an internal combustion engine control device according to a first embodiment will be described. Note that, in the drawings, the same reference numerals are given to common parts.

### Internal Combustion Engine System

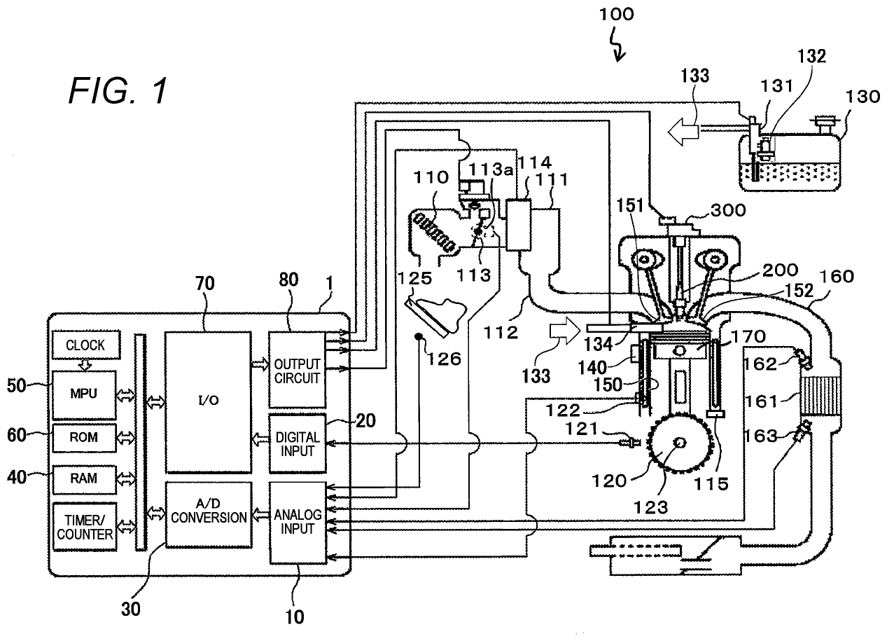

First, a configuration of an internal combustion engine system according to an embodiment will be described. FIG. 1 is an overall configuration diagram illustrating a configuration example of the internal combustion engine according to the embodiment of the present invention.

An internal combustion engine 100 illustrated in FIG. 1 may have a single cylinder or a plurality of cylinders, but in the embodiment, an internal combustion engine 100 having four cylinders will be described as an example.

As illustrated in FIG. 1, in the internal combustion engine 100, air (intake air) sucked from the outside flows through an air cleaner 110, an intake pipe 111, and an intake manifold 112. The air passing through the intake manifold 112 flows into each cylinder 150 when an intake valve 151 is opened. The amount of air flowing into each cylinder 150 is adjusted by a throttle valve 113. The amount of air adjusted by the throttle valve 113 is measured by a flow rate sensor 114.

The throttle valve 113 is provided with a throttle opening degree sensor 113a that detects the opening degree of the throttle. The opening degree information of the throttle valve 113 detected by the throttle opening degree sensor 113a is output to a control device (Electronic Control Unit: ECU) 1.

In the present embodiment, an electronic throttle valve driven by an electric motor is applied as the throttle valve 113. However, as the throttle valve according to the present invention, other types may be applied as long as the flow rate of air can be appropriately adjusted.

The temperature of the air flowing into each cylinder 150 is detected by an intake air temperature sensor 115.

A crank angle sensor 121 is provided radially outside a ring gear 120 attached to a crank shaft 123. The crank angle sensor 121 detects a rotation angle of the crank shaft 123. In the present embodiment, the crank angle sensor 121 detects the rotation angle of the crank shaft 123 every 10° and every combustion cycle.

A water temperature sensor 122 is provided in a water jacket (not illustrated) of a cylinder head. The water temperature sensor 122 detects the temperature of the cooling water of the internal combustion engine 100.

In addition, the vehicle is provided with an accelerator position sensor 126 that detects a displacement amount (depression amount) of an accelerator pedal 125. The accelerator position sensor 126 detects a request torque of the driver. The request torque of the torque detected by the accelerator position sensor 126 is output to the internal combustion engine control device 1 described later. The internal combustion engine control device 1 controls the throttle valve 113 on the basis of the request torque.

The fuel stored in the fuel tank 130 is sucked and pressurized by the fuel pump 131. The fuel sucked and pressurized by the fuel pump 131 is adjusted to a predetermined pressure by a pressure regulator 132 provided together with the fuel pump 131 in the fuel tank 130. Then, the fuel adjusted to a predetermined pressure is supplied to a fuel injection device (injector) 134 through a fuel pipe 133 and injected into each cylinder 150. Note that excess fuel generated by the pressure adjustment of the pressure regulator 132 is discharged from the pressure regulator 132 to the fuel tank 130.

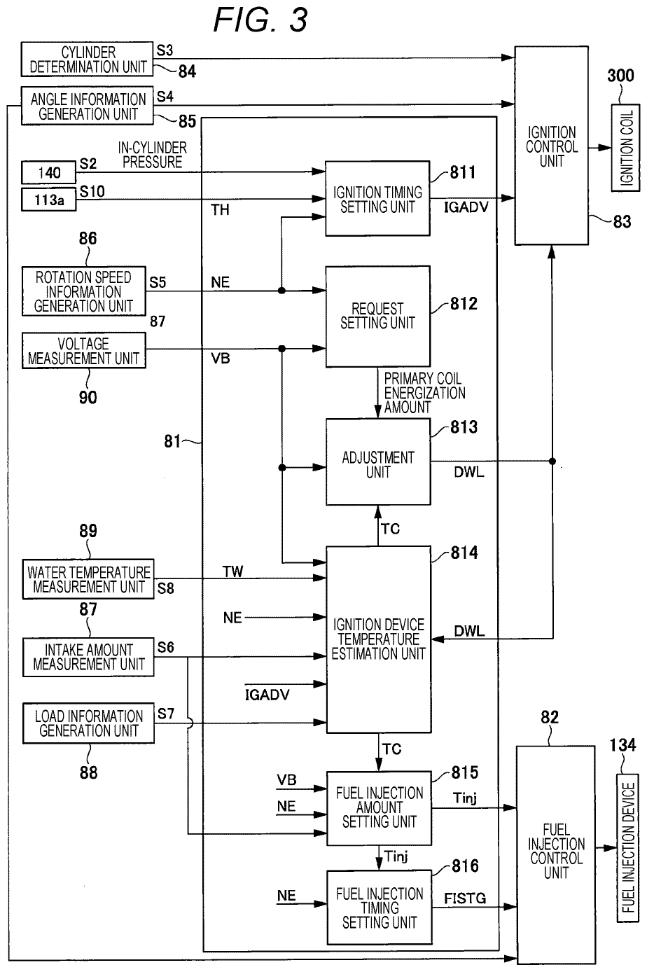

The control of the fuel injection device 134 is performed on the basis of a fuel injection pulse (control signal) of a fuel injection control unit 82 (see FIG. 3) of the internal combustion engine control device 1 described later.

An in-cylinder pressure sensor (also referred to as a cylinder pressure sensor or a combustion pressure sensor) 140 is provided in a cylinder head (not illustrated) facing a combustion chamber of the internal combustion engine 100. The in-cylinder pressure sensor 140 is provided in the cylinder 150 and detects the pressure (combustion pressure) in the cylinder 150. For example, a piezoelectric or gauge pressure sensor is applied as the in-cylinder pressure sensor 140. As a result, the in-cylinder pressure in the cylinder 150 can be detected.

An exhaust valve 152 and an exhaust manifold 160 are attached to each cylinder 150. When the exhaust valve 152 is opened, the exhaust gas is discharged from the cylinder 150 to the exhaust manifold 160. The exhaust manifold 160 discharges the burnt gas (exhaust gas) to the outside of the cylinder 150. A three-way catalyst 161 is provided on the exhaust side of the exhaust manifold 160. The three-way Catalyst 161 purifies the exhaust gas. The exhaust gas purified by the three-way catalyst 161 is discharged to the atmosphere.

An upstream air-fuel ratio sensor 162 is provided on the upstream side of the three-way catalyst 161. The upstream air-fuel ratio sensor 162 outputs a signal corresponding to the oxygen concentration related to the air-fuel ratio of the exhaust gas discharged from each cylinder 150. The upstream air-fuel ratio sensor 162 of the present embodiment is a so-called linear air-fuel ratio sensor that detects the air-fuel ratio (oxygen concentration) of the exhaust gas discharged from each cylinder 150 as a voltage that changes proportionally (linearly) to the air-fuel ratio.

A downstream air-fuel ratio sensor 163 is provided on the downstream side of the three-way catalyst 161. The downstream air-fuel ratio sensor 163 outputs a signal corresponding to the oxygen concentration related to the air-fuel ratio of the exhaust gas purified by the three-way catalyst 161. The downstream air-fuel ratio sensor 163 of the present embodiment is a so-called O2 sensor that outputs a detection signal that changes in a binary manner according to whether the air-fuel ratio is thicker (richer) or thinner (leaner) than the theoretical air-fuel ratio.

An ignition plug 200 is provided at a portion facing each combustion chamber of each cylinder 150. The ignition plug 200 generates sparks by discharge (ignition), and the spark ignites an air-fuel mixture of air and fuel in the cylinder 150. As a result, explosive combustion occurs in the cylinder 150, and a piston 170 is pushed down. When the piston 170 is pushed down, the crank shaft 123 rotates. An ignition coil 300 that generates (boosts) a discharge voltage supplied to the ignition plug 200 is connected to the ignition plug 200.

Output signals from various sensors such as the throttle opening degree sensor 113a, the flow rate sensor 114, the crank angle sensor 121, the accelerator position sensor 126, the water temperature sensor 122, and the in-cylinder pressure sensor 140 described above are input to the internal combustion engine control device 1 (hereinafter referred to as a “control device 1”). The control device 1 controls the amount of air passing through the throttle valve 113, the fuel injection amounts of the fuel pump 131 and the fuel injection device 134, the ignition timing of the ignition plug 200 by the ignition coil 300, and the like on the basis of signals from these various sensors.

### Ignition Plug

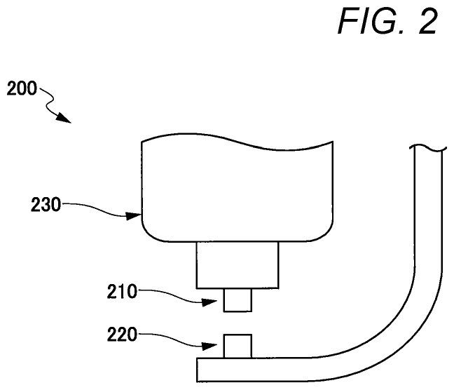

Next, the ignition plug 200 will be described with reference to FIG. 2.

FIG. 2 is a partially enlarged view illustrating the ignition plug 200.

As illustrated in FIG. 2, the ignition plug 200 includes a center electrode 210 and an outer electrode 220. The center electrode 210 is supported by a plug base (not illustrated) through an insulator 230. £ Thus, the center electrode 210 is insulated. The outer electrode 220 is grounded.

When a voltage is generated in the ignition coil 300 (see FIG. 1), a predetermined voltage (for example, 20,000 V to 40,000 V) is applied to the center electrode 210. When a predetermined voltage is applied to the center electrode 210, discharge (ignition) occurs between the center electrode 210 and the outer electrode 220. Then, sparks generated by the discharge ignite an air-fuel mixture (gas component) of air and fuel in the cylinder 150.

Note that the voltage at which discharge (ignition) occurs due to dielectric breakdown of the gas component in the cylinder 150 varies depending on the state of the gas (air-fuel mixture in the cylinder) existing between the center electrode 210 and the outer electrode 220 and the in-cylinder pressure of the cylinder 150. The voltage at which this discharge occurs is referred to as a dielectric breakdown voltage.

The discharge control (ignition control) of the ignition plug 200 is performed by an ignition control unit 83 (see FIG. 3) of the control device 1 described later.

### Hardware Configuration of Control Device

Next, an overall configuration of hardware of the control device 1 will be described.

As illustrated in FIG. 1, the control device 1 includes an analog input unit 10, a digital input unit 20, an analog/digital (A/D) conversion unit 30, a random access memory (RAM) 40, a micro-processing unit (MPU) 50, a read only memory (ROM) 60, an input/output (I/O) port 70, and an output circuit 80.

The analog input unit 10 receives analog output signals from various sensors such as the throttle opening degree sensor 113a, the flow rate sensor 114, the accelerator position sensor 126, the upstream air-fuel ratio sensor 162, the downstream air-fuel ratio sensor 163, the in-cylinder pressure sensor 140, and the water temperature sensor 122.

The A/D converter 30 is connected to the analog input unit 10. The analog output signals from the various sensors input to the analog input unit 10 are subjected to signal processing such as noise removal, and then converted into digital signals by the A/D converter 30. Then, the digital signal converted by the A/D converter 30 is stored in the RAM 40.

A digital output signal from the crank angle sensor 121 is input to the digital input unit 20. The digital input unit 20 is connected to the I/0 port 70. The digital output signal input to the digital input unit 20 is stored in the RAM 40 via the I/O port 70.

Each output signal stored in the RAM 40 is subjected to arithmetic processing by the MPU 50.

The MPU 50 executes a control program (not illustrated) stored in the ROM 60 to process the output signal stored in the RAM 40 according to the control program. The MPU 50 calculates a control value that defines the operation amount of each actuator (for example, the throttle valve 113, the fuel injection device 134, the fuel pump 131, the ignition coil 300, and the like) that drives the internal combustion engine 100 according to the control program, and temporarily stores the control value in the RAM 40.

The control value that defines the operation amount of each actuator stored in the RAM 40 is output to the output circuit 80 via the I/O port 70.

The drive device of the throttle valve 113, the fuel pump 131, the fuel injection device 134, and the ignition coil 300 are electrically connected to the output circuit 80.

### Functional Block of Control Device

Next, a functional configuration of the control device 1 will be described with reference to FIG. 3.

FIG. 3 is a functional block diagram illustrating the functional configuration of the control device 1.

As illustrated in FIG. 3, the control device 1 is provided with the above-described output circuit 80. In the present embodiment, the output circuit 80 includes an overall control unit 81, a fuel injection control unit 82, and an ignition control unit 83. Furthermore, the control device 1 is provided with a cylinder discrimination unit 84, an angle information generation unit 85, a rotation speed information generation unit 86, an intake amount measurement unit 87, a load information generation unit 88, a water temperature measurement unit 89, and a voltage measurement unit 90.

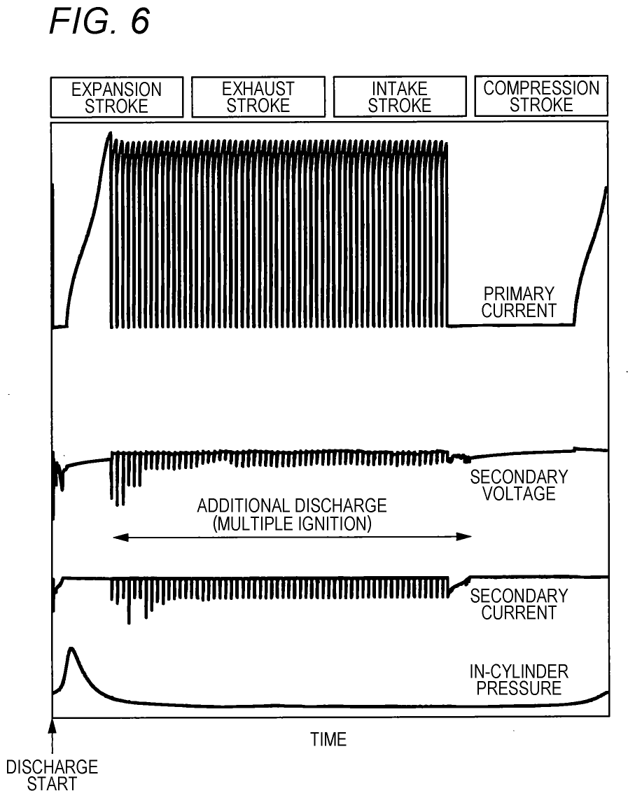

The angle information generation unit 85 measures the crank angle of the crank shaft 123 on the basis of the digital output signal of the crank angle sensor 121. The cylinder discrimination unit 84 discriminates which stroke (for example, an expansion, compression, intake or compression stroke as illustrated in FIG. 6) of each cylinder 150 of the internal combustion engine 100 the current crank angle measured by the angle information generation unit 85 corresponds to. The rotation speed information generation unit 86 measures the engine rotation speed.

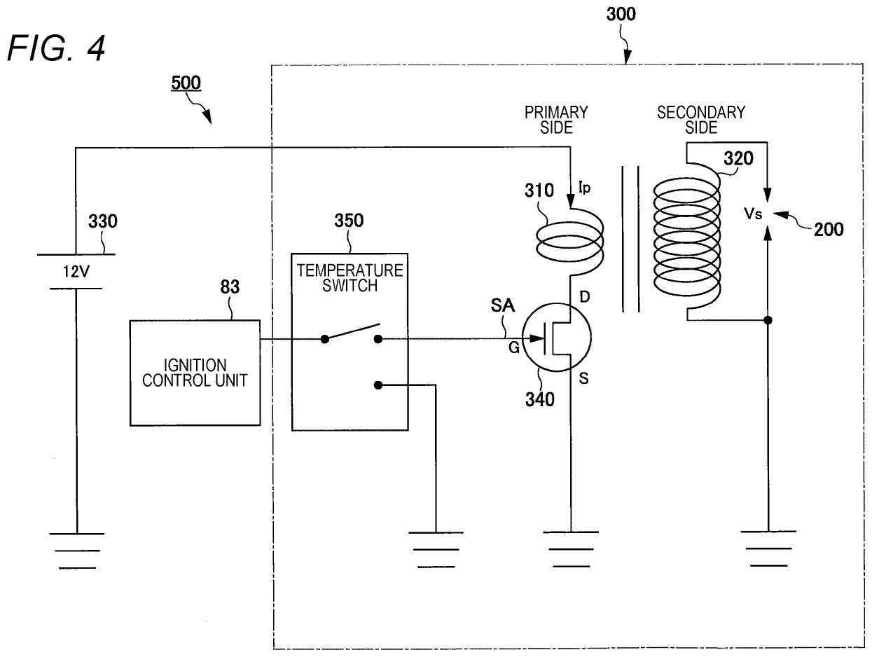

The intake amount measurement unit 87 measures an intake amount of air taken into the cylinder 150 on the basis of an output signal of the flow rate sensor 114. The load information generation unit 88 calculates the request torque of the driver on the basis of the output signal 41 the accelerator position sensor 126. The water temperature measurement unit 89 measures a temperature of engine cooling water. The voltage measurement unit 90 measures a voltage of a DC power supply 330 (battery of the internal combustion engine 100) illustrated in FIG. 4.

### Overall Control Unit

The overall control unit 81 includes an ignition timing setting unit 811, a request setting unit 812, an adjustment unit 813, an ignition device temperature estimation unit 814, a fuel injection amount setting unit 815, and a fuel injection timing setting unit 816.

The ignition timing setting unit 811 optimally calculates an ignition timing IGADV, which is the main operation amount of the internal combustion engine 100, on the basis of the operation state of the internal combustion engine 100 obtained from the outputs of various sensors such as an output signal S2 of the in-cylinder pressure sensor 140.

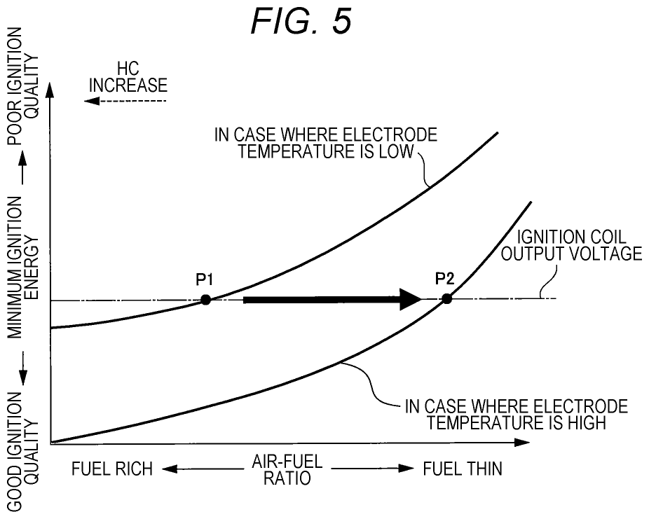

The request setting unit 812 calculates a request energization time (request energization amount) on the basis of the operation state of the internal combustion engine 100 obtained from outputs of various sensors such as a rotation speed NE and a power supply voltage VB of the internal combustion engine 100. The request energization time is a time for energizing a primary coil 310 (see FIG. 5) of the ignition coil 300 requested at the time of ignition.

The adjustment unit 813 calculates the energization time for energizing the primary coil 310 (see FIG. 5) of the ignition coil 300 on the basis of a temperature value (ignition coil temperature) TC related to the ignition device obtained from the ignition device temperature estimation unit 814 and the request energization time (request energization amount) obtained from the request setting unit.

The ignition device temperature estimation unit 814 calculates a temperature value (ignition coil temperature) TC related to the ignition device using a neural network model having a preselected explanatory variable as an input.

The fuel injection amount setting unit 815 optimally calculates a fuel injection amount, which is a main operation amount of the internal combustion engine 100, on the basis of an operation state of the internal combustion engine 100 obtained from outputs of various sensors such as the rotation speed NE and the power supply voltage VB of the internal combustion engine 100.

The fuel injection timing setting unit 816 optimally calculates the opening/closing operation timing of the fuel injection valve in the fuel injection device 134 on the basis of the operating state of the internal combustion engine 100 obtained from the outputs of various sensors such as the rotation speed NE of the internal combustion engine 100 and the fuel injection amount obtained from the fuel injection amount setting unit 815.

### Fuel Injection Control Unit

The fuel injection control unit 82 controls energization timing and energization time of the fuel injection valve. The fuel injection control unit 82 generates a fuel injection pulse on the basis of fuel control information input from the overall control unit 81. The fuel injection control unit 82 supplies the generated fuel injection pulse to the fuel injection control unit 82. The fuel injection device 134 is driven according to the fuel injection pulse.

The fuel control information includes, for example, a value of the fuel injection amount obtained from the fuel injection amount setting unit 815, the number of times of fuel injection execution for each combustion cycle of the internal combustion engine 100, opening/closing operation timing of the fuel injection valve obtained from the fuel injection timing setting unit 816, and the like.

### Ignition Control Unit

The ignition control unit 83 controls energization timing and energization time of the ignition coil 300. The ignition control unit 83 calculates the energization start timing (energization start crank angle) of the primary coil 310 on the basis of the ignition control information input from the overall control unit 81. The energization start timing of the primary coil 310 is a timing obtained by going back the energization time in time series from the ignition timing at which the current energized to the primary coil 310 is cut off.

The ignition control information includes, for example, engine rotation speed information S5, a value of ignition timing (crank angle from spark generation timing to compression top dead center of the internal combustion engine), a value of energization time obtained from the adjustment unit 813, and the like.

The ignition control unit 83 starts energization to the primary coil 310 on the basis of the calculated energization start timing, and outputs an ignition signal SA (see FIG. 4) for cutting off energization to the primary coil 310 on the basis of the ignition timing. As a result, ignition of the air-fuel mixture by the ignition plug 200 is executed.

### Electrical Circuit Including Ignition Coil

Next, an electrical circuit including an ignition coil will be described with reference to FIG. 4.

FIG. 4 is a diagram for explaining an electrical circuit including an ignition coil.

An electrical circuit 500 illustrated in FIG. 4 includes the ignition coil 300. The ignition coil 300 includes a primary coil 310 wound with a predetermined number of windings and a secondary coil 320 wound with a larger number of windings than the primary coil 310.

One end of the primary coil 310 is connected to the DC power supply 330. As a result, a predetermined voltage (for example, 12 V) is applied to the primary coil 310. The other end of the primary coil 310 is connected to a drain (D) terminal of an igniter (energization control circuit) 340 and is grounded through the igniter 340. As the igniter 340, a transistor, a field effect transistor (FET), or the like is used.

A gate (G) terminal of the igniter 340 is connected to the ignition control unit 83 through a temperature switch unit 350. The temperature switch unit 350 is installed for the purpose of preventing damage due to overheating of the ignition coil 300. When the temperature of the ignition coil 300 becomes equal to or higher than a predetermined threshold value A (first temperature), the temperature switch unit 350 cuts off the ignition signal SA output from the ignition control unit 83 to the igniter 340.

When the temperature switch unit 350 cuts off the ignition signal SA, energization to the primary coil 310 is stopped, so that overheating of the igniter 340 can be avoided. The ignition signal SA output from the ignition control unit 83 in a case where a temperature detected by a temperature detection unit 351 is lower than the first temperature is input to the gate (G) terminal of the igniter 340.

When the ignition signal SA is input to the gate (G) terminal of the igniter 340, the drain (D) terminal and a source(S) terminal of the igniter 340 are energized, and a current flows between the drain (D) terminal and the source (S) terminal. As a result, the ignition signal SA is output from the ignition control unit 83 to the primary coil 310 of the ignition coil 300 via the igniter 340. As a result, a current flows through the primary coil 310, and power (electric energy) is accumulated.

When the output of the ignition signal SA from the ignition control unit 83 is stopped, the current flowing through the primary coil 310 is cut off. As a result, a high voltage corresponding to the winding number ratio of the coil to the primary coil 310 is generated in the secondary coil 320.

The high voltage generated in the secondary coil 320 is applied to the center electrode 210 (see FIG. 2) of the ignition plug 200. As a result, a potential difference is generated between the center electrode 210 of the ignition plug 200 and the outer electrode 220. When the potential difference generated between the center electrode 210 and the outer electrode 220 becomes equal to or larger than a dielectric breakdown voltage Vm of the surrounding gas (air-fuel mixture in the cylinder 150), the gas component undergoes dielectric breakdown, and discharge occurs between the center electrode 210 and the outer electrode 220. As a result, the fuel (air-fuel mixture) is ignited (ignited). The ignition plug 200 and the electrical circuit 500 including the ignition coil 300 correspond to the ignition device according to the present invention.

The discharge path generated between the center electrode 210 and the outer electrode 220 has a high temperature of several thousand °C. Since the discharge path is in contact with the ambient gas and the electrodes 210 and 220, the heat generation energy of the discharge is distributed to the ambient gas and the electrodes 210 and 220. The heat generation energy distributed to the ambient gas heats (preheats) the ambient gas and the electrodes 210 and 220 to promote ignition.

### Temperature of Electrode, Minimum Ignition Energy, and Air-fuel Ratio

Next, the relationship between the temperature of the electrode of the ignition plug 200, the minimum ignition energy, and the air-fuel ratio will be described with reference to FIG. 5.

FIG. 5 is a diagram for explaining the relationship among the temperature of the electrode, the minimum ignition energy, and the air-fuel ratio.

FIG. 5 illustrates values of air-fuel ratios corresponding to values of minimum ignition energy. In FIG. 5, the up-down direction indicates the voltage scale value corresponding to the minimum ignition energy of the air-fuel mixture, and the left-right direction direction indicates the air-fuel ratio scale value corresponding to the air-fuel ratio of the air-fuel mixture. An air-fuel ratio P1 illustrated in FIG. 5 is a value of the air-fuel ratio corresponding to a predetermined value of the minimum ignition energy that can ignite the air-fuel mixture in a state where the electrode temperature of the ignition plug is low (for example, minus 25 degC) . On the other hand, the air-fuel ratio P2 is a value of the air-fuel ratio corresponding to a predetermined value of the minimum ignition energy that can ignite the air-fuel mixture in a state where the electrode temperature of the ignition plug is high (for example, minus 7 degC).

As illustrated in FIG. 5, in the internal combustion engine 100, as the air-fuel ratio increases (the fuel becomes thinner), the value of the minimum ignition energy of the air-fuel mixture increases, so that the air-fuel mixture is less likely to be ignited by discharge (ignition) from the ignition plug. In addition, since the value of the minimum ignition energy of the air-fuel mixture increases as the electrode temperature of the ignition plug decreases, it is difficult to ignite the air-fuel mixture by discharge (ignition) from the ignition plug.

For example, it is assumed that a value equivalent to the minimum ignition energy corresponding to the air-fuel ratio P2 in a state where the electrode temperature of the ignition plug is high is obtained in a state where the electrode temperature of the ignition plug is low. In this case, the discharge (ignition) from the ignition plug 200 cannot exceed the minimum ignition energy unless the air-fuel ratio is set to the air-fuel ratio P1 that is a value smaller than the air-fuel ratio P2 (fuel is thick) . Therefore, conventionally, as a setting having a safety margin that does not cause inconvenience such as misfire in the internal combustion engine 100, the rich air-fuel ratio (P1) on the premise that the temperature of the electrode of the ignition plug 200 is always low is set in the fuel injection control unit 82. As a result, in the internal combustion engine 100, the generation of hydrocarbon (HC) at the time of combustion increases as the ratio of fuel in the air-fuel mixture increases.

On the other hand, the higher the temperature of the electrode of the ignition plug 200 at the time of cooling start (see the thick arrow in FIG. 5), the lower the minimum ignition energy for igniting the air-fuel mixture. Therefore, even if the air-fuel ratio is increased (the fuel is thinned), the discharge (ignition) from the ignition plug exceeds the minimum ignition energy, and the air-fuel mixture can be ignited. As a result, generation of hydrocarbon (HC) in the internal combustion engine 100 can be reduced. Therefore, in the internal combustion engine 100, as described later, the temperature of the electrode of the ignition plug 200 at the time of cooling start is increased before discharge (ignition). This makes it possible to increase the air-fuel ratio at the time of cooling start and to suppress the generation of hydrocarbon (HC).

### Multiple Ignition

Next, multiple ignition will be described with reference to FIG. 6.

FIG. 6 is a discharge waveform example of multiple ignition.

In an internal combustion engine, it is known that a large amount of hydrocarbon (HC) is generated at the time of cooling start when the temperature of each part is about the same as the outside air temperature. One of the factors that generate hydrocarbon at the time of cooling start is that the fuel vaporized by the ignition timing decreases due to the low in-cylinder temperature, and the air-fuel ratio of the in-cylinder air-fuel mixture increases (the fuel is diluted). In this case, the request ignition energy increases, and ignition failure and extinction (misfire) increase, so that hydrocarbon increases. That is, the main cause of hydrocarbon generation is misfire.

The misfire occurs when a flame kernel generated by ignition cannot grow and is extinguished. In order to grow the flame kernel and suppress misfire, it is necessary to suppress ambient gas in a discharge path facing between the electrodes 210 and 220 of the ignition plug 200 (see FIG. 2) and the amount of heat transferred from the flame kernel to the electrodes 210 and 220. For example, if multiple ignition is executed in the ignition device to preheat the electrodes 210 and 220 of the ignition plug 200, the temperature difference between the discharge path and the flame kernel and the electrodes 210 and 220 is reduced. As a result, the amount of heat transferred from the discharge path or the flame kernel to the electrodes 210 and 220 can be suppressed.

As illustrated in FIG. 6, by repeating ON and OFF of the ignition signal, multiple ignitions are performed by adding a plurality of times of discharge. As a result, the temperature of the electrodes 210 and 220 of the ignition plug 200 can be increased before ignition of the main ignition of the ignition plug 200 (discharge at the ignition timing). The multiple ignition by the additional discharge can be performed at a timing not overlapping with the ignition timing of the main ignition. For example, the multiple ignition by the additional discharge can be performed at least in a period from the ignition of the main ignition to the start of fuel injection (a period from the expansion stroke to the intake stroke in the embodiment of FIG. 6).

### Temperature and Discharge Energy of Ignition Coil

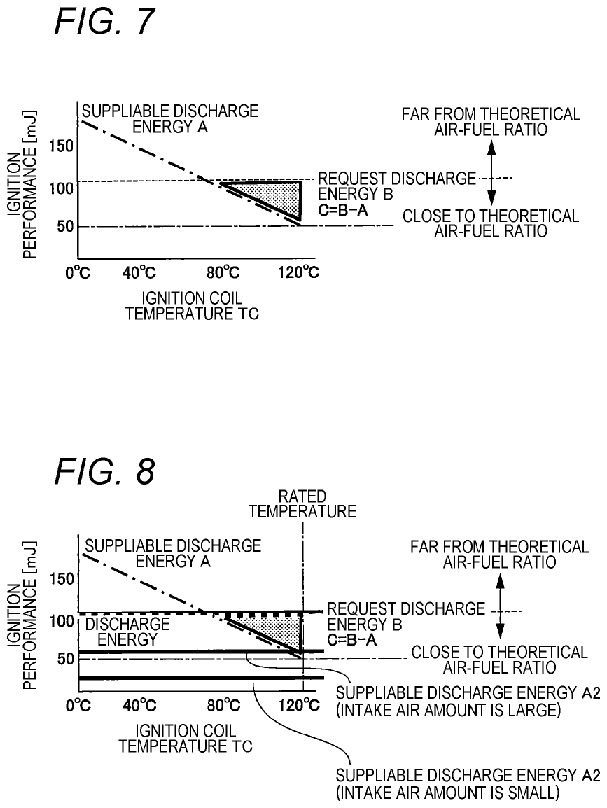

Next, the temperature and the discharge energy of the ignition coil 300 will be described with reference to FIG. 7.

FIG. 7 is a conceptual diagram illustrating a relationship between the suppliable discharge energy and the request discharge energy with respect to the temperature of the ignition coil.

In the graph illustrated in FIG. 7, the horizontal axis represents the temperature TC (hereinafter, referred to as an “ignition coil temperature TC”) of the ignition coil 300 (see FIG. 4), and the vertical axis represents the ignition performance indicated by the unit of discharge energy megajoule (mJ). The ignition performance includes, for example, request discharge energy set according to an operation state of the internal combustion engine 100 on the basis of the above-described minimum ignition energy required to ignite the air-fuel mixture, and suppliable discharge energy serving as an upper limit value for making the ignition coil temperature TC equal to or lower than the rated temperature. As described above, the request discharge energy is affected by the air-fuel ratio of the air-fuel mixture, the exhaust gas recirculation amount, and the like. In addition, the suppliable discharge energy tends to increase as the ignition coil temperature TC deviates from the rated temperature. For example, in a case where the rated temperature is set to 120 degC in FIG. 7, when the ignition coil temperature TC decreases to 80 degC and 40 degC lower than the rated temperature, the value of the suppliable discharge energy increases according to the temperature decrease.

Since a high current of, for example, about 15 A flows through the primary coil 310 of the ignition coil 300 and the igniter 340, instantaneous heat generation is repeated every time ignition is executed. Therefore, the suppliable discharge energy A is set based on o the ignition coil temperature TC, and the energization of the ignition coil 300 is controlled on the basis of the suppliable discharge energy A so that the temperatures of the primary coil 310 of the ignition coil 300 and the igniter 340 do not exceed the preset rated temperature (the designed heat-resistant temperature of each component). The discharge energy A that can be supplied by the ignition coil 300 decreases as the ignition coil temperature TC increases and approaches the rated temperature.

Request discharge energy B is mainly affected by the state of the air-fuel mixture in the vicinity of the ignition plug electrode, that is, the air-fuel ratio and the intake flow. The request discharge energy B has a substantially minimum value when the air-fuel ratio of the air-fuel mixture is close to the theoretical air-fuel ratio (stoichiometric). On the other hand, the request discharge energy B increases as the air-fuel ratio deviates from the theoretical air-fuel ratio.

In general, inclinations of the suppliable discharge energy A and the request discharge energy B with respect to the temperature axis of the ignition coil temperature TC indicated in the left-right direction in FIG. 7 are different. Therefore, as illustrated in FIG. 7, the suppliable discharge energy A and the request discharge energy B intersect. At this time, for example, when the temperature at the point where the two discharge energies A and B intersect is higher than the rated temperature (design use temperature range) of the ignition coil 300, the discharge energy A equal to or higher than the request discharge energy B can be always output from the ignition coil 300 without exceeding the rated temperature. In this case, the ignition performance of the internal combustion engine 100 is always satisfied without being restricted by the temperature of the ignition coil 300.

On the other hand, in order to improve the fuel consumption of the vehicle, for example, when a lean combustion technique is implemented in which an air-fuel mixture larger than the theoretical air-fuel ratio (fuel is thinner) is burned to operate the internal combustion engine, the request discharge energy B increases as the air-fuel ratio of the air-fuel mixture deviates from the theoretical air-fuel ratio. Therefore, the temperature at the point where the two discharge energies A and B intersect may fall below the rated temperature of the ignition coil 300 (within the use temperature range). In this case, it is difficult to continuously supply the request discharge energy B exceeding the suppliable discharge energy A to the ignition coil 300 on a higher temperature side than the temperature of the intersecting point. Therefore, the practicability of a so-called fuel consumption improvement technique such as lean combustion and exhaust gas recirculation of the internal combustion engine 100 is restricted by the shortage of the suppliable discharge energy A on the higher temperature side than the temperature of the point where the two discharge energies A and B intersect.

Hereinafter, a difference value between the suppliable discharge energy A and the request discharge energy B when the suppliable discharge energy A is lower than the request discharge energy B is defined as an ignition performance insufficiency C.

Relationship between Temperature of Conventional Ignition Coil and Discharge Energy

Next, the relationship between the temperature of the conventional ignition coil and the discharge energy will be described with reference to FIG. 8.

FIG. 8 is a conceptual diagram illustrating a relationship between a temperature and discharge energy of a conventional ignition coil.

The horizontal axis of the graph illustrated in FIG. 8 represents the ignition coil temperature TC, and the vertical axis represents the ignition performance. In addition, a thick line in FIG. 8 is discharge energy output from the conventional ignition coil. As illustrated in FIG. 8, in the ignition device of the related art (see, for example, JP 2000-054941 A), since the value of the ignition coil temperature TC is not clear, for example, when 120 degc is set as the rated temperature in FIG. 8, a suppliable discharge energy A2 at 120 degC is always applied as the output limit value of the discharge energy by the ignition coil. That is, in the conventional ignition device, the suppliable discharge energy A2 is substantially unchanged with respect to the change in the ignition coil temperature TC. In other words, the conventional ignition device is designed such that the temperature at the point where the suppliable discharge energy A2 and the request discharge energy B intersect is higher than the rated temperature of the ignition coil in a case where ignition is performed in a state where the air-fuel ratio is close to the theoretical air-fuel ratio. Therefore, the ignition performance of the internal combustion engine 100 to which the conventional ignition device is applied is always satisfied without being restricted by the temperature of the ignition coil 300 at least on the condition that ignition is performed in a state where the air-fuel ratio is close to the theoretical air-fuel ratio.

However, when lean combustion or exhaust gas recirculation in which a part of the burned exhaust gas is taken in and sucked again is performed, the request discharge energy B is higher than in a case where the air-fuel mixture is ignited in a state close to the theoretical air-fuel ratio as described above, so that the temperature at the point where the two discharge energies A and B intersect is lower than the rated temperature. In this case, on the higher temperature side than the temperature at the point where the suppliable discharge energy A and the request discharge energy B intersect, the ignition performance insufficiency C increases in accordance with the increase in the ignition coil temperature TC, and thus there is a possibility that misfire occurs. Under such circumstances, in the internal combustion engine to which the conventional ignition device is applied, restriction is imposed so that the lean combustion and the exhaust gas recirculation are performed only under a low load situation in which the amount of air flowing into the cylinder is reduced and the request discharge energy B is reduced.

Relationship between Temperature of Ignition Coil and Discharge Energy According to Present Invention

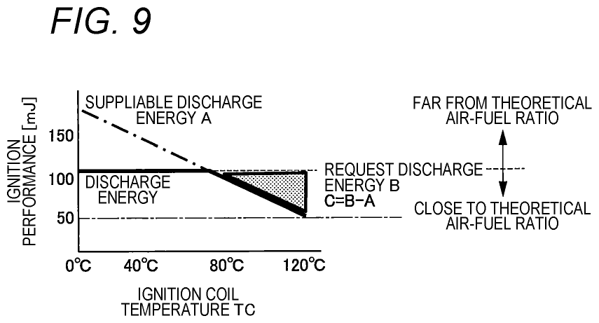

Next, the relationship between the temperature of the ignition coil and the discharge energy according to the present invention will be described with reference to FIG. 9.

FIG. 9 is a conceptual diagram illustrating a relationship between a temperature of an ignition coil and discharge energy in a case where the present invention is applied.

The horizontal axis of the graph illustrated in FIG. 9 represents the ignition coil temperature TC, and the vertical axis represents the ignition performance. In addition, a thick line in FIG. 9 is discharge energy output from the ignition coil 300. As illustrated in FIG. 9, in the present embodiment, when the temperature of the ignition coil 300 becomes higher than the temperature at the point where the suppliable discharge energy A and the request discharge energy B intersect, the suppliable discharge energy A is prioritized over the request discharge energy B.

That is, in the present embodiment, when the ignition coil temperature TC becomes higher than the temperature at the point where the suppliable discharge energy A and the request discharge energy B intersect, the discharge energy of the ignition coil 300 is set to the suppliable discharge energy A. As a result, when the discharge energy of the ignition coil 300 becomes higher than the temperature at the point where the suppliable discharge energy A and the request discharge energy B intersect, the discharge energy is gradually reduced as the ignition coil temperature TC rises.

Note that, on the higher temperature side than the temperature at the point where the suppliable discharge energy A and the request discharge energy B intersect, in the present embodiment, the fuel injection amount can be increased so that ignition is performed in a state where the air-fuel ratio is close to the theoretical air-fuel ratio, and the value of the request discharge energy B can be substantially lowered. That is, in the present embodiment, the ignition quality of the air-fuel mixture is enhanced to compensate for insufficient ignition performance by reducing the discharge energy. As a result, it is possible to satisfy the requested ignition performance while lowering the value of the request discharge energy B to prevent overheating of the ignition coil 300. As a result, misfire can be suppressed. In the present embodiment, the value of the request discharge energy B can be made higher than that of the conventional ignition device in order to perform lean combustion and exhaust gas recirculation on the lower temperature side than the temperature of the point where the suppliable discharge energy A and the request discharge energy B intersect. As a result, even under a high load situation where the request discharge energy B is maximized due to an increase in the amount of air flowing into the cylinder or the like, it is possible to more perform lean combustion and exhaust gas recirculation than the conventional ignition device while achieving both misfire prevention and overheat prevention of the ignition coil 300. As a result, the fuel consumption of the vehicle can be improved.

As described above, in the present embodiment, the discharge energy of the ignition coil 300 is changed according to the temperature of the ignition coil 300. Therefore, it is necessary to grasp the temperature of the ignition coil 300 (the temperature of the ignition device). The temperature of the ignition coil 300 can be detected, for example, by providing a temperature sensor.

However, if the temperature sensor is provided in the ignition coil 300, the cost increases along with an increase in the detection element and the wiring, or the casing increases in size. Therefore, in the present embodiment, the temperature of the ignition coil 300 is estimated without providing the temperature sensor. This makes it possible to suppress an increase in cost and an increase in size of the casing while suppressing misfire.

### Ignition and Fuel Injection Control Processing

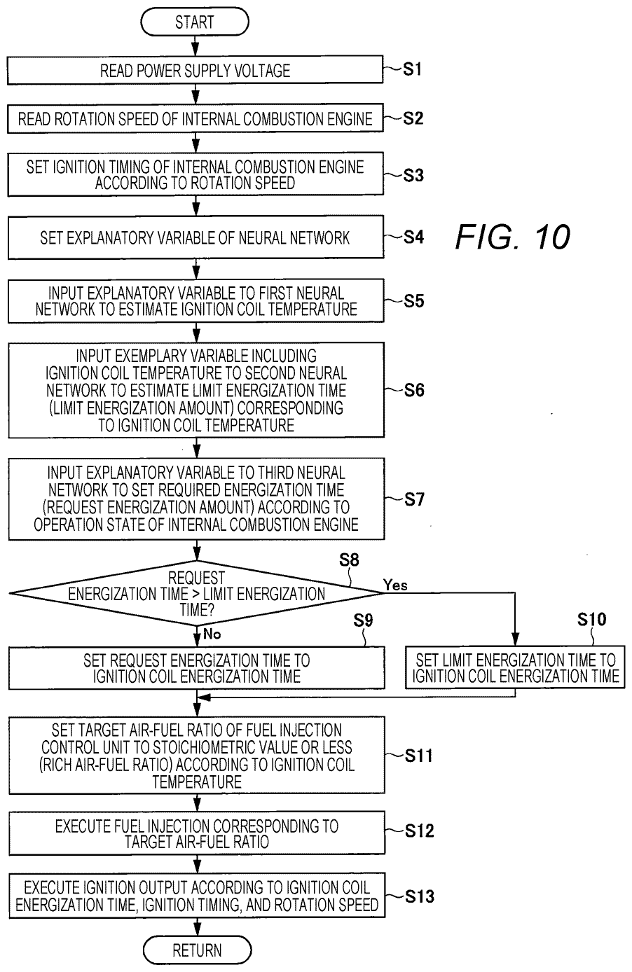

Next, ignition and fuel injection control processing according to the first embodiment will be described with reference to FIG. 10.

FIG. 10 is a flowchart illustrating the ignition and fuel injection control processing according to the first embodiment.

The ignition and fuel injection control processing is started together with the start of the internal combustion engine 100 (engine start). First, the overall control unit 81 acquires the power supply voltage VB (S1). Subsequently, the overall control unit 81 acquires the rotation speed NE of the internal combustion engine 100 (S2). Next, the ignition timing setting unit 811 of the overall control unit 81 sets the ignition timing of the internal combustion engine 100 according to the rotation speed NE (S3).

Next, the overall control unit 81 sets explanatory variables of the neural network model (S4). In the present embodiment, a plurality of explanatory variables selected in advance from various parameter groups including the temperature of the ignition coil 300 and the operating state of the internal combustion engine 100 related to the parameter regarding the heat balance inside and outside the ignition device are set through detection, estimation, or calculation.

Next, the ignition device temperature estimation unit 814 of the overall control unit 81 inputs an explanatory variable to the first neural network model and estimates a temperature value (ignition coil temperature) TC related to the ignition device (S5). The explanatory variables input to the first neural network model include at least the power supply voltage VB and the rotation speed NE.

Next, the adjustment unit 813 of the overall control unit 81 inputs the explanatory variable to the second neural network model and outputs the limit energization time according to the ignition coil temperature TC (S6). The explanatory variables input to the second neural network model include at least the power supply voltage VB, the rotation speed NE, and the ignition coil temperature TC.

The limit energization time is an upper limit value of the time during which the current is energized to the ignition coil 300 (primary coil 310), and corresponds to the above-described suppliable discharge energy A. Therefore, the limit energization time can also be referred to as a limit energization amount.

Next, the request setting unit 812 of the overall control unit 81 inputs an explanatory variable to the third neural network model and outputs a request energization time according to the operation state of the internal combustion engine 100 (S7). The explanatory variables input to the third neural network model include at least the power supply voltage VB and the rotation speed NE.

The request energization time is a time for energizing a current to the ignition coil 300 (primary coil 310) to satisfy the request discharge energy B. Therefore, the request energization time can also be referred to as a request energization amount.

Next, the adjustment unit 813 of the overall control unit 81 determines whether or not the request energization time is larger than the limit energization time (S8). When it is determined in step S8 that the request energization time is not larger than the limit energization time (NO in S8), the adjustment unit 813 sets the request energization time as the energization time of the ignition coil 300 (hereinafter, referred to as an “ignition coil energization time”) (S9).

On the other hand, when it is determined in step S8 that the request energization time is larger than the limit energization time (YES in S8), the adjustment unit 813 sets the limit energization time as the ignition coil energization time (S10).

After the processing of step S9 or step S10, the fuel injection amount setting unit 815 of the overall control unit 81 sets the target air-fuel ratio of the fuel injection control unit 82 to a stoichiometric value according to the ignition coil temperature TC (S11). In the processing of step S11, for example, when the ignition performance is deteriorated by setting the limit energization time to the ignition coil energization time, a value of a target air-fuel ratio related to determination of a fuel injection amount Tinj in the fuel injection control unit 82 is set to the theoretical air-fuel ratio at which the request discharge energy B becomes the minimum value or a value close to the theoretical air-fuel ratio as described above according to the ignition coil temperature TC. As a result, the value of the minimum ignition energy of the air-fuel mixture can be reduced (the request discharge energy B can be reduced) to suppress misfire.

Next, the fuel injection control unit 82 causes the fuel injection device 134 to execute fuel injection (S12). Specifically, the fuel injection control unit 82 energizes the fuel injection device 134 with the fuel injection amount Tinj based on the target air-fuel ratio set in step S11 and the drive current (drive voltage) according to the fuel injection timing set by the fuel injection timing setting unit 816.

Next, the ignition control unit 83 causes the ignition device to execute ignition (S13). Specifically, the ignition control unit 83 outputs the ignition signal SA corresponding to the ignition coil energization time set in steps S9 and S10, the ignition timing IGADV set in step S3, and the rotation speed NE to the ignition coil 300. After the processing of step S13, the overall control unit 81 returns the processing to step S1.

### Neural Network Model

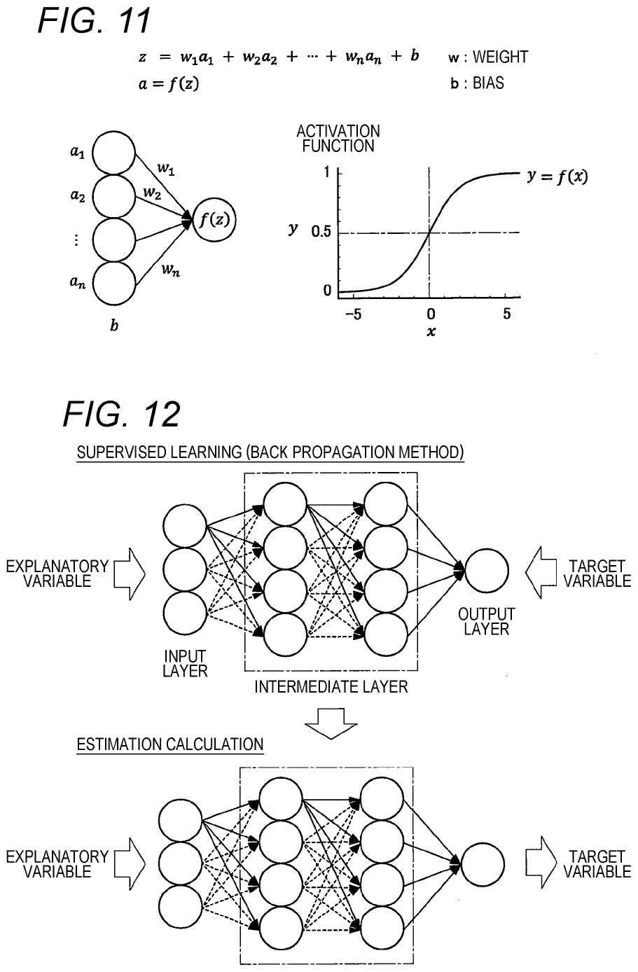

Next, the neural network model according to the present embodiment will be described with reference to FIGS. 11, 12, and 13.

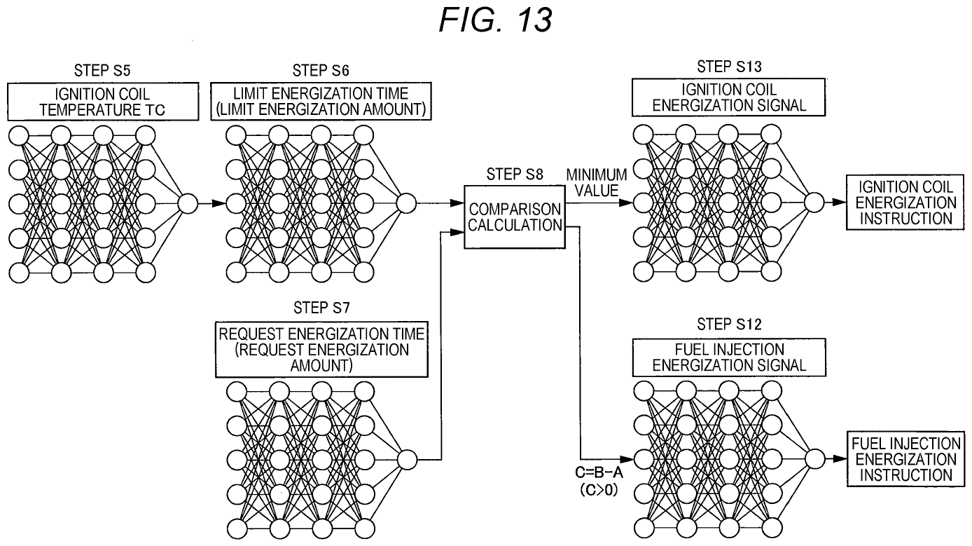

FIG. 11 is a conceptual diagram illustrating the weight and bias of each neuron constituting each neural network model such as a first neural network model having the ignition coil temperature TC as an objective variable, a second neural network model having the limit energization time as an objective variable, and a third neural network model having the request energization time as an objective variable. FIG. 12 is a diagram for explaining a method of realizing the operation of each objective variable by the neural network model according to the present embodiment. FIG. 13 is a conceptual diagram illustrating a neural network model used for ignition and fuel injection control processing according to the first embodiment.

The neural network model is a mathematical model that simulates a mechanism of a human cranial nerve circuit. In the present embodiment, the neural network model is constituted by a multilayer neural network model provided with an input layer to which an explanatory variable is input, an output layer that outputs an objective variable, and an intermediate layer that connects the input layer and the output layer. The neural network model is often used as a means for performing deep learning in so-called machine learning. For example, an error back propagation method can be applied to a machine learning algorithm. Note that, although the neural network model is used in the present embodiment, the present invention is not limited to this example as long as the estimation of the ignition coil temperature TC and the limit energization time and the request energization time can be determined by machine learning.

As illustrated in FIG. 11, a weight w and a bias b are set to each neuron (unit) constituting the neural network model. Inputs a1 to an are respectively input to n neurons, and weights w1 to wn set for the respective neurons are multiplied. Then, the inputs a1 to a multiplied by the weights w1 to wn in the neurons in the next layer are added (combined), and the output z in which the bias b is added to the addition result is obtained. The neuron in the next layer outputs a represented by a function f (z).

In addition, a function called an activation function is defined for each neuron. For the activation function, a logistic function (sigmoid function), a ramp function (rectified linear unit (ReLU) function), and the like are appropriately set. FIG. 11 illustrates an example in which the larger the input x is than 0, the more the neuron is activated and the closer the output y (=f (x) ) is to 1, and the smaller the input x is than 0, the more the neuron is deactivated and the closer it is to 0. For example, when the input x is “5”, the output y of the activation function is “1”, and “1” is output from the neuron to the neuron in the next layer.

As also illustrated in FIG. 12, the intermediate layer of the multilayer neural network model is configured such that a plurality of layers formed by a plurality of neurons are superimposed. By configuring a large-scale neural network model in which the number of neurons and the number of intermediate layers are arranged in large numbers, it is possible to learn a complicated input/output relationship and increase the accuracy of approximation of the objective variable. However, there is a trade-off relationship between increasing the accuracy of approximation and the magnitude of the scale of the neural network model. Therefore, the neural network model of the control device of the internal combustion engine of the vehicle according to the present embodiment is configured and provided after considering in advance a so-called cost effective compatibility point that balances both the desired accuracy of approximation and the demand of the model scale in consideration of the arithmetic processing capability of the control device 1, the casing size, the cost suppression, and the like.

Further, the input/output relationship of the neural network model can be approximated with high accuracy by setting a variable having a causal relationship with the objective variable in the input layer as the train data of the explanatory variable and setting the objective variable in the output layer as the train data, and then performing machine learning (supervised learning) on the weight w and the bias b to a plurality of neurons in the intermediate layer using a known algorithm such as an error back propagation method. In the learned model subjected to such learning, when the explanatory variable used for machine learning as the train data is input to the input layer, the calculation of the input/output relationship based on the learned content is executed, and the value of the objective variable based on the input explanatory variable is output as the calculation result.

A neural network model of the ignition and fuel injection control processing according to the first embodiment of the present invention will be described with reference to FIGS. 10 and 13.

FIG. 13 illustrates an input/output relationship of each of an explanatory variable and an objective variable between a plurality of neural network models in the ignition and fuel injection control processing according to the first embodiment of the present invention illustrated in FIG. 10. Note that, in addition to the first, second, and third neural network models used in the processing of steps S5, S6, and S7 described above, the ignition and fuel injection control processing according to the present embodiment can be configured to use the fourth neural network model for the fuel injection control of step S12 and an estimation algorithm using the fifth neural network model for the ignition control of step S13.

In the present embodiment, first, a plurality of explanatory variables including the power supply voltage VB and the rotation speed NE having a causal relationship with the ignition coil temperature TC are set in the input layer of the first neural network model subjected to learning with the ignition coil temperature TC as an objective variable, and the ignition coil temperature TC is output from the output layer through the arithmetic processing in the intermediate layer as described above (step S5). Next, a plurality of explanatory variables including the power supply voltage VB and the rotation speed NE having a causal relationship with the limit energization time, and the ignition coil temperature TC output from the first neural network model described above are set in the input layer of the second neural network model subjected to learning with the limit energization time of the ignition coil 300 as an objective variable, and the limit energization time is output from the output layer through calculation processing in the intermediate layer (step S6). Further, a plurality of explanatory variables including the power supply voltage VB and the rotation speed NE having a causal relationship with the request energization time are set in the input layer of the third neural network model subjected to learning using the request energization time as an objective variable, and the request energization time is output from the output layer through arithmetic processing in the intermediate layer (step S7). Subsequently, the limit energization time output from the second neural network model and the request energization time output from the third neural network model are set in the comparison calculation of the request setting unit 812 (step S8), and the ignition coil energization time is set on the basis of the comparison result between the limit energization time and the request energization time (Steps S8, S9, and S10).

Next, a plurality of explanatory variables including the fuel injection amount according to the target air-fuel ratio (step S11) set according to the power supply voltage VB, the rotation speed NE, and the ignition coil temperature TC having a causal relationship with the opening/closing operation timing of the fuel injection valve are set in the input layer of the fourth neural network model subjected to learning using the opening/closing operation timing of the fuel injection valve as an objective variable, and the opening/closing operation timing of the fuel injection valve corresponding to the crank angle measured by the angle information generation unit 85 is output from the output layer through the arithmetic processing in the intermediate layer (step S12). Subsequently, a plurality of explanatory variables including the rotation speed NE, the ignition timing IGADV, and the ignition coil energization time having a causal relationship with the ignition signal SA are set in the input layer of the fifth neural network model subjected to learning using the energization instruction to the ignition coil, that is, the ignition signal SA output to the igniter 340 as an objective variable, and the ignition signal SA corresponding to the crank angle measured by the angle information generation unit 85 is output from the output layer through the calculation processing in the intermediate layer (step S13). As illustrated in FIG. 13, the ignition and fuel injection control processing of the first embodiment illustrated in FIG. 10 can be configured using first to fifth neural network models.

Relationship between Objective Variable and Explanatory Variable

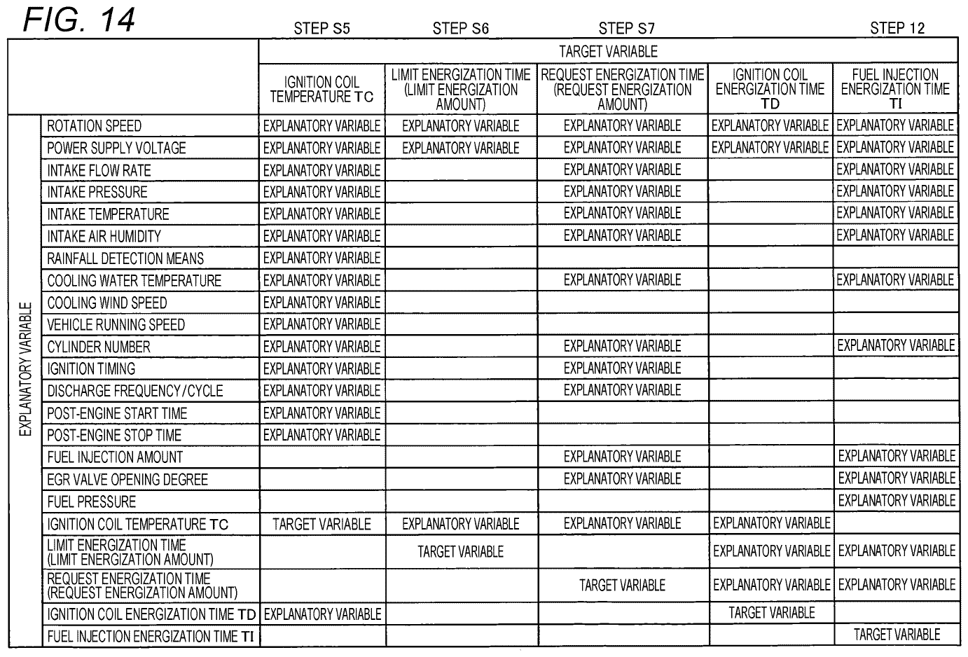

Next, a relationship between the objective variable and the explanatory variable according to the present embodiment will be described with reference to FIG. 14.

FIG. 14 is a correspondence table illustrating a relationship between objective variables and explanatory variables of the first to fifth neural network models according to the first embodiment. An example of an explanatory variable input for estimating (calculating) each objective variable is illustrated.

As illustrated in FIG. 14, in the case of estimating the ignition coil temperature TC as the objective variable in the first neural network model, in addition to the rotation speed NE and the power supply voltage VB described above, a variable selected from an intake flow rate, an intake pressure, an intake temperature, an intake humidity, a rainfall (rainfall detection), a cooling water temperature, a value related to a cooling wind speed, a vehicle traveling speed, an ignition timing, an ignition coil energization time (executed value), the number of times of energization/an energization cycle, an elapsed time after start of the engine (internal combustion engine), an elapsed time after stop of the engine (internal combustion engine), and suppliable discharge energy (previously calculated value) is input as an explanatory variable to the first neural network model, and machine learning is performed for a plurality of neurons in the intermediate layer.

Note that, in addition to the explanatory variables described above, explanatory variables that can be further added to the first neural network model include, for example, the combustion pressure detected by the in-cylinder pressure sensor, the lubricating oil temperature, a value related to a crank angle at which each intake valve/exhaust valve of the internal combustion engine is opened or a crank angle at which each valve is closed, an accelerator opening degree, an ignition coil temperature TC (previous value), an ignition coil energization time, an air-fuel ratio feedback correction coefficient, a downstream air-fuel ratio sensor (O2 sensor) voltage, an upstream air-fuel ratio sensor (linear air-fuel ratio sensor) voltage, a value related to a property (octane number or the like) of fuel supplied to the internal combustion engine, an operating state of a radiator fan, a torque, an intake amount, a fuel injection amount, an air-fuel ratio or an equivalent ratio, a value of an in-exhaust pipe pressure associated with exhaust gas recirculation, and the like. Some or all of these are selected in view of the magnitude of a causal relationship with the ignition coil temperature TC as the objective variable, the magnitude of the neural network model as described above, the easiness of acquisition of the variables in the control device 1, and the like, and the required variables can be set as explanatory variables of the first neural network model.

### Explanatory Variable

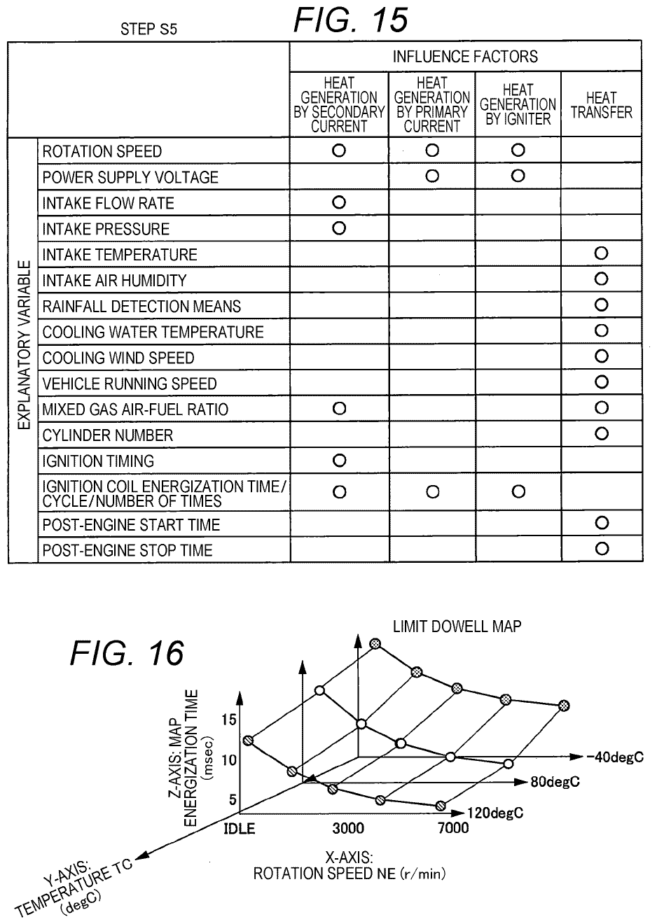

Next, a method of selecting an explanatory variable for estimating the ignition coil temperature TC will be described with reference to FIG. 15.

FIG. 15 is a table illustrating an example of variables related to an influence factor considered when selecting an explanatory variable for estimating the ignition coil temperature TC according to the first embodiment.

The influence factors related to the fluctuation of the ignition coil temperature TC include a factor related to internal heat generation of the ignition coil and a factor related to external heat transfer. The magnitude of the absolute value of the correlation coefficient with the ignition coil temperature TC is considered for each variable illustrated in FIG. 15. Then, for example, the variables are selected as explanatory variables of the first neural network model in descending order of the correlation coefficient.

The internal heat generation of the ignition coil includes heat generation by the secondary current, heat generation by the primary current, and heat generation in the igniter 340 (see FIG. 4). This heat generation occurs due to a power loss in an internal circuit of the ignition coil. Therefore, for each internal heat generation, a variable having a large correlation coefficient is selected as an explanatory variable. Examples of variables having a large correlation coefficient with heat generation by the secondary current include the rotation speed NE, the intake flow rate, the intake pressure, the mixed gas air-fuel ratio, the ignition timing, and the ignition coil energization time/number of energizations/cycle. Examples of variables having a large correlation coefficient with the primary current and heat generation by the igniter include the rotation speed NE, the power supply voltage VB, and the ignition coil energization time/number of energizations/cycle.

The external heat transfer of the ignition coil occurs at a contact portion outside the casing of the ignition coil 300. The objects in direct contact with the ignition coil 300 are, for example, air (atmosphere), an ignition plug, and a cylinder head in an ignition coil of a type in which an ignition coil is disposed adjacent to an ignition plug for each cylinder of the internal combustion engine 1. Therefore, a variable having a large correlation coefficient is selected as an explanatory variable for each object in direct contact with the ignition coil 300. For example, variables having a large correlation coefficient with the external heat transfer include an intake air temperature, an intake air humidity, a rainfall amount, a cooling water temperature, a lubricating oil temperature, a cooling wind speed, a vehicle traveling speed, a mixed gas air-fuel ratio, a cylinder number, an elapsed time after starting an engine (internal combustion engine), and an elapsed time after stopping the engine (internal combustion engine).

In the present embodiment, an example has been described in which the request energization amount and the limit energization amount in a case where sparks are generated by discharge (ignition) to ignite the air-fuel mixture are determined, and the ignition coil energization amount is adjusted. The discharge (ignition) is intermittently performed for one combustion cycle of the internal combustion engine 100 (one ignition for each compression top dead center every two revolutions of the crank), or the discharge and ignition are performed for each compression top dead center and exhaust top dead center. In addition, the present invention may be applied to a case where additional discharge in the ignition plug is performed multiple times in addition to ignition at the top dead center (a case where the above-described multiple ignition is performed). That is, on the basis of the total amount of the request energization amount and the limit energization amount for one combustion cycle of the internal combustion engine 100, the respective ignition coil energization amounts of ignition at the compression top dead center, per rotation ignition, or multiple ignition may be individually adjusted. For example, the energization time of the ignition coil at the compression top dead center is set on the basis of the request energization amount, and each energization time of the ignition coil of discharge at the exhaust top dead center or discharge by multiple ignition can be set by dividing and calculating a value obtained by subtracting the request energization amount from the total amount of the limit energization amount for one combustion cycle of the internal combustion engine 100 according to the scheduled number of times of discharge at the exhaust top dead center or discharge by multiple ignition. Further, the discharge at the exhaust top dead center or the discharge by multiple ignition is executed on the lower temperature side than the temperature at the point where the suppliable discharge energy A and the request discharge energy B intersect as illustrated in FIG. 9.

### Second Embodiment

Hereinafter, an internal combustion engine control device according to a second embodiment will be described. The internal combustion engine control device according to the second embodiment is different from the internal combustion engine control device according to the first embodiment in ignition and fuel injection control processing. Therefore, here, the ignition and fuel injection control processing of the internal combustion engine control device according to the second embodiment will be described, and the description of the common configuration will be omitted.

A ROM 60 of the internal combustion engine control device according to the second embodiment stores a limit dwell map used when calculating a limit energization amount (suppliable discharge energy A), a request dwell map used when calculating a request energization amount (request discharge energy B), and a voltage correction coefficient map.

### Limit Dwell Map

The limit dwell map stored in the ROM 60 will be described with reference to FIG. 16.

FIG. 16 is a diagram for explaining the limit dwell map.

The X-axis of FIG. 16 represents the rotation speed NE, and the Y-axis of FIG. 16 represents the ignition coil temperature TC. The Z axis of FIG. 16 represents the limit energization time. The limit energization time is a variable representing the limit energization amount (suppliable discharge energy A) as a time for energizing a current to the ignition coil 300 (primary coil 310).

The limit dwell map is map data in a list format that defines a plurality of limit energization times by associating a plurality of index values (for example, 40, 80, 120 degC) related to a plurality of ignition coil temperatures TC and a plurality of index values (for example, the idling rotation speed IDLE, 3000, 7000 r/min) related to a plurality of rotation speeds NE with each other. The adjustment unit 813 according to the second embodiment calculates the limit energization time according to the value of the ignition coil temperature TC and the value of the rotation speed NE on the basis of the value defined in the limit dwell map. Note that, in the present embodiment, as illustrated by a linear line connecting points of a plurality of index values in FIG. 16, when the value of the ignition coil temperature TC and the value of the rotation speed NE correspond to values located between a plurality of index values, it is possible to calculate the limit energization time by performing linear interpolation calculation connecting points of a plurality of index values close to each other.

### Request Dwell Map

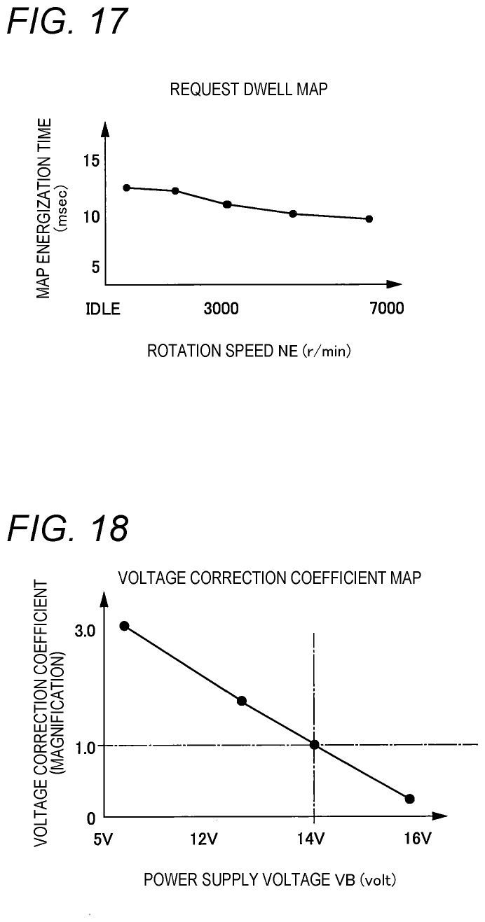

The request dwell map stored in the ROM 60 will be described with reference to FIG. 17.

FIG. 17 is a diagram for explaining the request dwell map.

The horizontal axis of the graph illustrated in FIG. 17 represents the rotation speed NE, and the vertical axis of the graph illustrated in FIG. 17 represents the map energization time. The map energization time is a variable used when a request energization time to be described later is calculated.

The request dwell map is map data in a table format that defines a plurality of map I energization times by associating a plurality of index values (for example, the idling rotation speed IDLE, 3000, 7000 r/min) related to a plurality of rotation speeds NE with each other. The request setting unit 812 according to the second embodiment calculates a map energization time corresponding to the value of the rotation speed NE on the basis of the value defined in the request dwell map.

voltage Correction Coefficient Map

The voltage correction coefficient map stored in the ROM 60 will be described with reference to FIG. 18.

FIG. 18 is a diagram for explaining the voltage correction coefficient map.

The horizontal axis of the graph illustrated in FIG. 18 represents the power supply voltage VB, and the vertical axis of the graph illustrated in FIG. 18 represents the voltage correction coefficient. The voltage correction coefficient is a coefficient used when a request energization time to be described later is calculated.

The voltage correction coefficient map is map data in a table format that defines a plurality of voltage correction coefficients by associating a plurality of index values (for example, 5, 12,14 V, 16 V) related to a plurality of power supply voltages VB with each other. In the second embodiment, the voltage correction coefficient corresponding to the value of the rotation speed NE is calculated on the basis of the value defined in the voltage correction coefficient map.

The request setting unit 812 according to the second embodiment calculates the request energization time (request energization amount) by multiplying the map energization time by the voltage correction coefficient. The request energization time is a variable representing the request energization amount (request discharge energy B) as a time for energizing a current to the ignition coil 300 (primary coil 310). That is, since the power consumption in the ignition coil 300 greatly affects the internal heat generation of the ignition coil affecting the ignition coil temperature TC, the request energization time is adjusted according to the value of the power supply voltage VB related to the power consumption.

### Ignition and Fuel Injection Control Processing

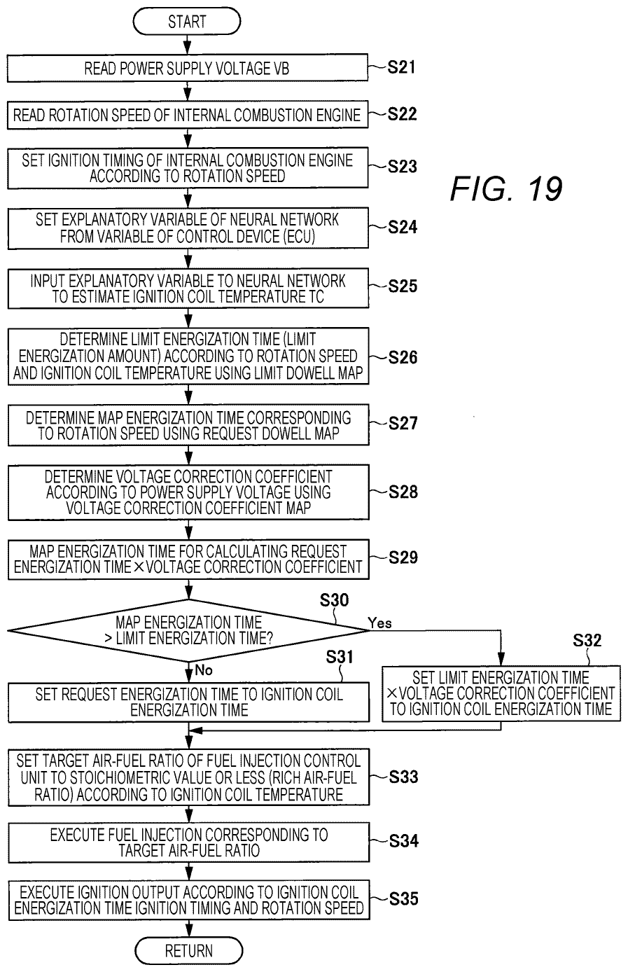

Next, ignition and fuel injection control processing according to the second embodiment will be described with reference to FIG. 19.

FIG. 19 is a flowchart illustrating the ignition and fuel injection control processing according to the second embodiment.

Steps S21 to S25 of the ignition and fuel injection control processing according to the second embodiment are the same as steps S1 to S5 of the ignition and fuel injection control processing according to the first embodiment. Therefore, description of steps S21 to S25 is omitted.

After the processing of step S25, the adjustment unit 813 of the overall control unit 81 determines the limit energization time (limit energization amount) according to the rotation speed NE and the ignition coil temperature TC using the limit dwell map (see FIG. 16) (S26).

Next, the request setting unit 812 of the overall control unit 81 determines a map energization time according to the rotation speed NE using the request dwell map (see FIG. 17) (S27). Next, the request setting unit 812 determines a voltage correction coefficient according to the power supply voltage VB using the voltage correction coefficient map (S28). Then, the request setting unit 812 calculates the request energization time (request energization amount) by multiplying the map energization time by the voltage correction coefficient (S29).

Next, the adjustment unit 813 of the overall control unit 81 determines whether or not the map energization time is larger than the limit energization time (S30). When it is determined in step S30 that the map energization time is not larger than the limit energization time (NO in S30), the adjustment unit 813 sets the request energization time (value obtained by multiplying the map energization time by the voltage correction coefficient) as the ignition coil energization time (S31).

On the other hand, when it is determined in step S30 that the request energization time is larger than the limit energization time (YES in S30), the adjustment unit 813 sets a value (limit energization amount) obtained by multiplying the voltage correction coefficient to the limit energization time to the ignition coil energization time (S32).

Steps S33 to S35 of the ignition and fuel injection control processing according to the second embodiment are the same as steps S11 to S13 of the ignition and fuel injection control processing according to the first embodiment. Therefore, description of steps S33 to S35 is omitted.

### Third Embodiment

Hereinafter, an internal combustion engine control device according to a third embodiment will be described. The internal combustion engine control device according to the third embodiment is different from the internal combustion engine control devices according to the first embodiment and the second embodiment in ignition and fuel injection control processing. Therefore, here, the ignition and fuel injection control processing of the internal combustion engine control device according to the third embodiment will be described, and the description of the common configuration will be omitted.

The ROM 60 of the internal combustion engine control device according to the third embodiment stores a request dwell map, a voltage correction coefficient map, and a temperature correction coefficient map used when ignition and fuel injection control processing is executed. The request dwell map and the voltage correction coefficient map are the same as the request dwell map (see FIG. 17) and the voltage correction coefficient map (see FIG. 18) of the second embodiment.

### Temperature Correction Coefficient Map

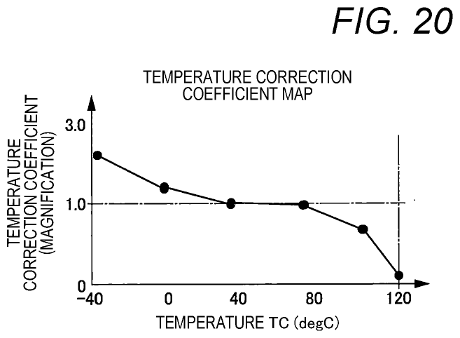

The temperature correction coefficient map stored in the ROM 60 will be described with reference to FIG. 20.

FIG. 20 is a diagram for explaining the temperature correction coefficient map.

The horizontal axis of the graph illustrated in FIG. 20 represents the ignition coil temperature TC, and the vertical axis of the graph illustrated in FIG. 18 represents the temperature correction coefficient. The temperature correction coefficient is used when an ignition coil energization time to be described later is calculated.

The temperature correction coefficient map is map data in a table format that defines a plurality of temperature correction coefficients by associating a plurality of index values (for example, −40, 0, 40, 80, 120 degC) related to a plurality of ignition coil temperatures TC with each other. The adjustment unit 813 according to the third embodiment calculates a temperature correction coefficient corresponding to the value of the ignition coil temperature TC on the basis of the value defined in the temperature correction coefficient map.

In the third embodiment, the ignition coil energization time is calculated by multiplying the request energization time (request energization amount) calculated by the request setting unit 812 by the temperature correction coefficient. That is, the ignition coil energization time is adjusted according to the temperature correction coefficient on the basis of the ignition coil temperature TC.

### Ignition and Fuel Injection Control Processing

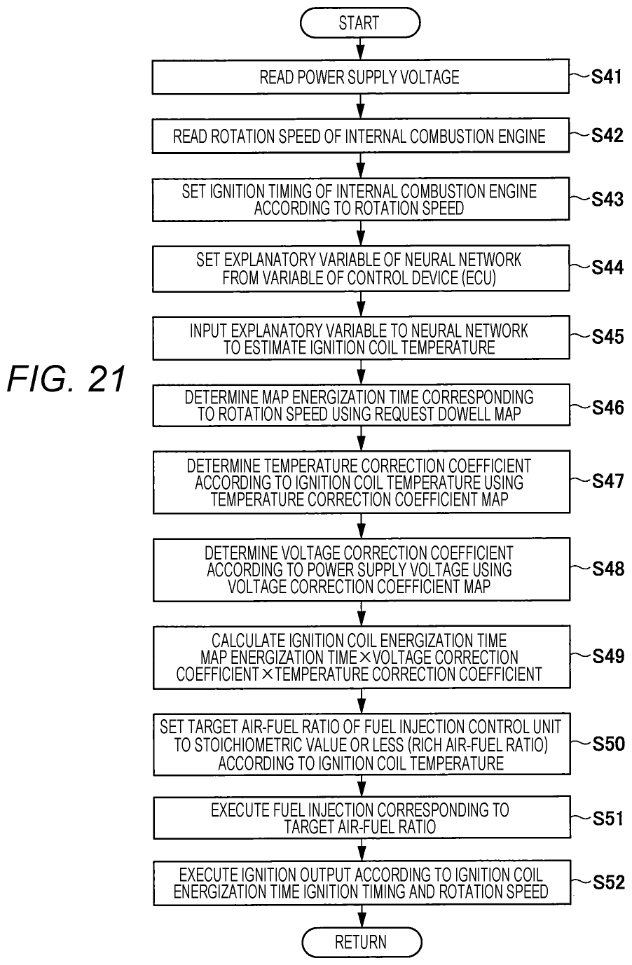

Next, ignition and fuel injection control processing according to the third embodiment will be described with reference to FIG. 21.

FIG. 21 is a flowchart illustrating the ignition and fuel injection control processing according to the third embodiment.

Steps S41 to S45 of the ignition and fuel injection control processing according to the third embodiment are the same as steps S1 to S5 of the ignition and fuel injection control processing according to the first embodiment. Therefore, description of steps S41 to S45 is omitted.

After the processing of step S45, the request setting unit 812 of the overall control unit 81 determines a map energization time (map energization amount) according to the rotation speed NE using the request dwell map (see FIG. 17) (S46).

Next, the adjustment unit 813 of the overall control unit 81 determines a temperature correction coefficient according to the ignition coil temperature TC using the temperature correction coefficient map (see FIG. 20) (S47). Next, the request setting unit 812 determines a voltage correction coefficient according to the power supply voltage VB using the voltage correction coefficient map (S48). After the processing of step S48, the processing proceeds to step S49, and the request setting unit 812 calculates the request energization time by multiplying the map energization time by the voltage correction coefficient. The request energization time is supplied to the adjustment unit 813. The adjustment unit 813 calculates the ignition coil energization time by multiplying the request energization time by the temperature correction coefficient (S49).

Steps S50 to S52 of the ignition and fuel injection control processing according to the third embodiment are the same as steps S11 to S13 of the ignition and fuel injection control processing according to the first embodiment. Therefore, description of steps S50 to S52 is omitted.

Note that, in the request setting unit 812 of each of the second embodiment and the third embodiment, the map energization time determined using the request dwell map illustrated in FIG. 17 is multiplied by the voltage correction coefficient to determine the request energization time (S29, S49). However, the calculation of the request energization time according to the present invention is not limited thereto. For example, the request dwell map may use a map of a configuration (not illustrated) that defines a plurality of request energization times (request energization amounts) by associating a plurality of index values related to a plurality of rotation speeds NE and a plurality of index values related to a plurality of power supply voltages VB with each other. In this case, the above-described voltage correction coefficient map (FIG. 18) and the multiplication of the map energization amount by the voltage correction coefficient can be omitted.

### Fourth Embodiment

Hereinafter, an internal combustion engine control device according to a fourth embodiment will be described. The internal combustion engine control device according to the fourth embodiment is different from the internal combustion engine control devices according to the first to third embodiments in ignition and fuel injection control processing. Therefore, here, the ignition and fuel injection control processing of the internal combustion engine control device according to the fourth embodiment will be described, and the description of the common configuration will be omitted.

The ROM 60 of the internal combustion engine control device according to the fourth embodiment stores a low-temperature request dwell map, a high-temperature request dwell map, and a voltage correction coefficient map to be used when ignition and fuel injection control processing is executed. The voltage correction coefficient map is the same as the voltage correction coefficient map of the second embodiment (see FIG. 18).

### Low-temperature Request Dwell Map

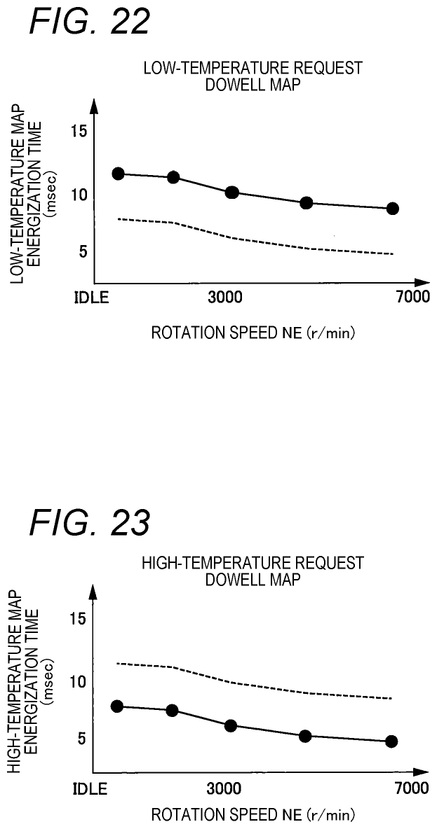

The low-temperature request dwell map stored in the ROM 60 will be described with reference to FIG. 22.

FIG. 22 is a diagram for explaining the low-temperature request dwell map.

The horizontal axis of the graph illustrated in FIG. 22 represents the rotation speed NE, and the vertical axis of the graph illustrated in FIG. 22 represents the low-temperature map energization time. As will be described later, the low-temperature map energization time (low-temperature map energization amount) is used when calculating the low-temperature ignition coil energization time used in a case where the ignition coil temperature TC is lower than a preset low-temperature set value. The low-temperature ignition coil energization time is also used when calculating the ignition coil energization time in a case where the ignition coil temperature TC is a value between a high-temperature set value and a low-temperature set value set in advance.

The low-temperature request dwell map defines a plurality of low-temperature map energization times (low-temperature map energization amounts) associating a plurality of index values relating to a plurality of values (for example, the idling rotation speed IDLE, 3000, 7000 r/min) of the rotation speed NE with each other. The request setting unit 812 according to the fourth embodiment calculates the low-temperature map energization time according to the value of the rotation speed NE on the basis of the value defined in the low-temperature request dwell map.

### High-Temperature Request Dwell Map

The high-temperature request dwell map stored in the ROM 60 will be described with reference to FIG. 23.

FIG. 23 is a diagram for explaining the high-temperature request dwell map.

The horizontal axis of the graph illustrated in FIG. 23 represents the rotation speed NE, and the vertical axis of the graph illustrated in FIG. 23 represents the high-temperature map energization time. As will be described later, the high-temperature map energization time (high-temperature map energization amount) is used when calculating the high-temperature ignition coil energization time in a case where the ignition coil temperature TC is higher than a preset high-temperature set value. In addition, the high-temperature ignition coil energization time is also used when calculating the ignition coil energization time in a case where the ignition coil temperature TC is a value between a high-temperature set value and a low-temperature set value set in advance.

The high-temperature request dwell map defines a plurality of high-temperature map energization times by associating a plurality of index values (for example, the idling rotation speed IDLE, 3000, 7000 r/min) related to a plurality of values of the rotation speeds NE with each other. The request setting unit 812 according to the fourth embodiment calculates the high-temperature map energization time according to the value of the rotation speed NE on the basis of the value defined in the high-temperature request dwell map.

### Ignition and Fuel Injection Control Processing

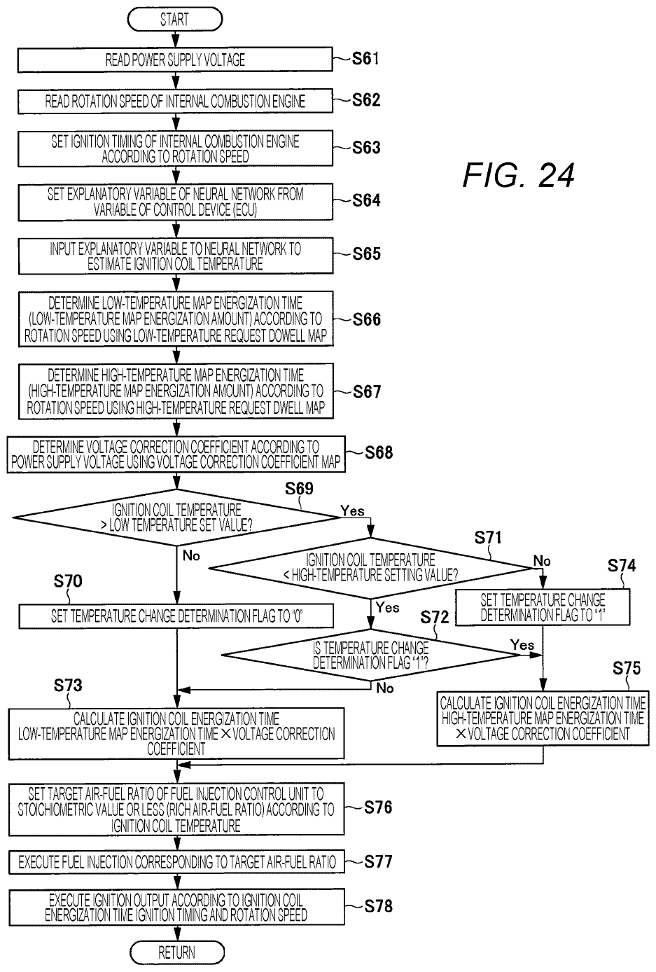

Next, ignition and fuel injection control processing according to the fourth embodiment will be described with reference to FIG. 24.

FIG. 24 is a flowchart illustrating the ignition and fuel injection control processing according to the fourth embodiment.

Steps 61 to 65 of the ignition and fuel injection control processing according to the fourth embodiment are the same as steps S1 to S5 of the ignition and fuel injection control processing according to the first embodiment. Therefore, description of steps S61 to S65 is omitted.

After the processing of step S65, the request setting unit 812 of the overall control unit 81 determines the low-temperature map energization time (low-temperature map energization amount) according to the rotation speed NE using the low-temperature request dwell map (S66). Next, the request setting unit 812 determines the high-temperature map energization time (high-temperature map energization amount) according to the value of the rotation speed NE using the high-temperature request dwell map (S67).

Next, the adjustment unit 813 of the overall control unit 81 determines a voltage correction coefficient corresponding to the value of the power supply voltage VB using the voltage correction coefficient map (S68). Then, the adjustment unit 813 determines whether or not the ignition coil temperature TC is higher than a predetermined low-temperature set value (S69).

When it is determined in step S69 that the ignition coil temperature TC is not higher than the predetermined low-temperature set value (NO in S69), the adjustment unit 813 sets “0” in the temperature change determination flag (S70).

When it is determined in step S69 that the ignition coil temperature TC is higher than the predetermined low-temperature set value (YES in S69), the adjustment unit 813 determines whether or not the ignition coil temperature TC is lower than the predetermined high-temperature set value (S71).

When it is determined in step S71 that the ignition coil temperature TC is lower than the predetermined high-temperature set value (YES in S71), the adjustment unit 813 determines whether or not the temperature change determination flag is “1” (S72). Note that the high-temperature set value is higher than the low-temperature set value.

When it is determined in step S72 that the temperature change determination flag is not “1” (NO in S72), the adjustment unit 813 performs the processing of step S73 described later.

When it is determined in step S72 that the temperature change determination flag is “1” (YES in step S72), the adjustment unit 813 performs processing of step S75 described later.

After the processing of step S70 or in a case where NO is determined in step S72, the adjustment unit 813 calculates the ignition coil energization time (ignition coil energization amount) by multiplying the low-temperature map energization time by the voltage correction coefficient (S73).

On the other hand, when it is determined in step S71 that the ignition coil temperature TC is not lower than the predetermined high-temperature set value (NO in S71), the adjustment unit 813 sets “1” in the temperature change determination flag (S74).

After the processing of step S74 or in a case where step S72 is YES, the adjustment unit 813 calculates the ignition coil energization time by multiplying the high-temperature map energization time by the voltage correction coefficient (S75).

Steps S76 to S78 of the ignition and fuel injection control processing according to the fourth embodiment are the same as steps S11 to S13 of the ignition and fuel injection control processing according to the first embodiment. Therefore, description of steps S76 to S78 is omitted.

As described above, the low-temperature request dwell map (see FIG. 22) and the high-temperature request dwell map (see FIG. 23) according to the fourth embodiment define the low-temperature map energization time and the high-temperature map energization time (map energization amount) corresponding to the value of the rotation speed NE. However, the low-temperature request dwell map and the high-temperature request dwell map according to the fourth embodiment may define the request energization time (request energization amount) corresponding to both the value of the rotation speed NE and the value of the power supply voltage VB.

In this case, the ignition coil energization time (ignition coil energization amount) for low temperature is determined using the low-temperature request dwell map (corresponding to S73), or the ignition coil energization time (ignition coil energization amount) for high temperature is determined using the high-temperature request dwell map (corresponding to S75). Note that, in this case, the calculation of the voltage correction coefficient (S68) and the multiplication of the voltage correction coefficient in steps S73 and S75 can be omitted.

In the fourth embodiment described above, the low-temperature map energization time and the high-temperature map energization time are switched using the low-temperature set value and the high-temperature set value, and the ignition coil energization time is determined to change stepwise in the temperature direction. However, when the ignition coil temperature TC is between the low-temperature set value and the high-temperature set value, the adjustment unit 813 according to the present invention may determine the ignition coil energization time by performing interpolation calculation of a value between the low-temperature map energization time and the high-temperature map energization time. That is, the ignition coil energization time may be set to change in a slope shape through interpolation calculation from the low-temperature set value to the high-temperature set value.

### Fifth Embodiment

Hereinafter, an internal combustion engine control device according to a fifth embodiment will be described. In the internal combustion engine control device according to the fifth embodiment, the internal combustion engine control device according to the first embodiment has a similar configuration. The internal combustion engine control device according to the fifth embodiment is different from the internal combustion engine control device according to the first embodiment in an electrical circuit including an ignition coil. Therefore, here, an electrical circuit including an ignition coil of the internal combustion engine control device according to the fifth embodiment will be described, and description of a common configuration will be omitted.

### Electrical Circuit Including Ignition Coil

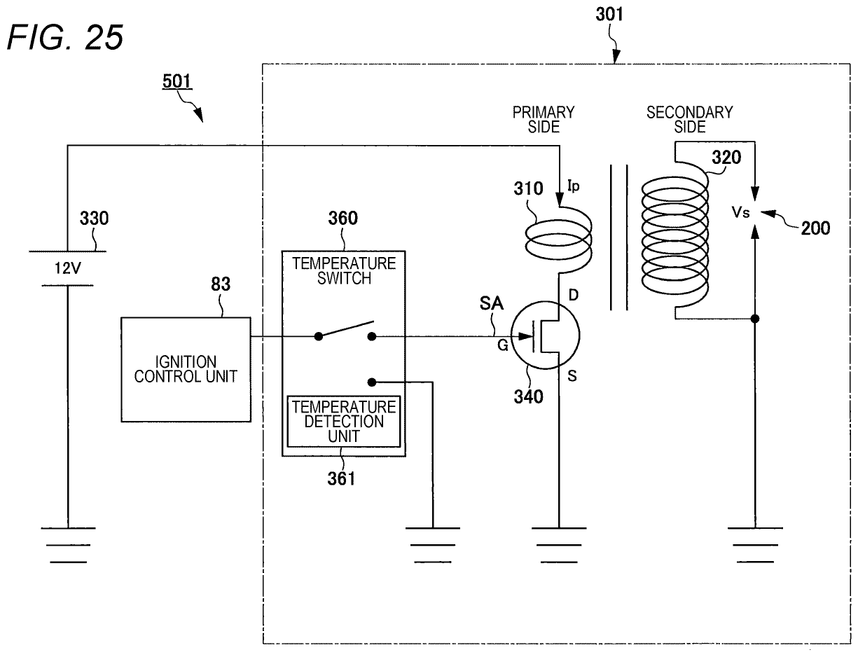

The electrical circuit including the ignition coil according to the fifth embodiment will be described with reference to FIG. 25.

FIG. 25 is a diagram for explaining the electrical circuit including the ignition coil according to the fifth embodiment.

An electrical circuit 501 illustrated in FIG. 25 includes an ignition coil 301. The ignition coil 301 includes a primary coil 310 wound with a predetermined number of turns and a secondary coil 320 wound with a larger number of turns than the primary coil 310. The primary coil 310 and the secondary coil 320 are the same as those in the first embodiment illustrated in FIG. 5.

The other end of the primary coil 310 is connected to a drain (D) terminal of an igniter (energization control circuit) 340 and is grounded through the igniter 340. A gate (G) terminal of the igniter 340 is connected to the ignition control unit 83 via a temperature switch unit 360.

The temperature switch unit 360 is installed for the purpose of preventing damage due to overheating of the ignition coil 301. The temperature switch unit 360 includes a temperature detection unit 361. The temperature detection unit 361 detects the temperature of the ignition coil 301 via the igniter 340. When the temperature detected by the temperature detection unit 361 becomes equal to or higher than a predetermined threshold value A (first temperature), the temperature switch unit 360 cuts off the ignition signal SA output from the ignition control unit 83 to the igniter 340.

An operation state of the temperature switch unit 360 corresponding to the threshold A (first temperature) is input to the overall control unit 81 (not illustrated). Therefore, the overall control unit 81 according to the fifth embodiment can read the ignition coil temperature TC as the first temperature on the basis of the operation state of the temperature switch unit 360. As described above, the internal combustion engine control device according to the present invention is not limited to the one that estimates the ignition coil temperature TC, and may include a temperature detection unit that detects the ignition coil temperature TC.

### Summary

(1) The control device 1 (internal combustion engine control device) according to the first embodiment described above controls the internal combustion engine 100 in which the current flowing through the ignition coil 300 of the ignition device is interrupted according to a predetermined ignition timing. The control device 1 includes the request setting unit 812, the adjustment unit 813, and the ignition control unit 83. The request setting unit 812 determines a request energization amount (request energization time) of the ignition coil 300 on the basis of the rotation speed NE of the internal combustion engine 100. The adjustment unit 813 adjusts the ignition coil energization time (the energization amount of the ignition coil) according to the ignition coil temperature TC (the temperature related to the ignition device) and the request energization amount. The ignition control unit 83 controls the interruption state of the ignition coil 300 according to the ignition coil energization time adjusted by the adjustment unit 813.

As a result, the heat balance of the ignition device of the ignition coil 300 can be appropriately controlled. As a result, it is possible to suppress an increase in size and cost of the ignition device.
(2) The ROM 60 (storage unit) according to the second embodiment described above stores the request dwell map, the limit dwell map, and the voltage correction coefficient map. The request dwell map defines the relationship between the rotation speed NE and the map energization amount. The limit dwell map defines the relationship between the rotation speed NE and the ignition coil temperature TC (temperature related to the ignition device), and the limit energization amount that is an energization amount that can be supplied to the ignition coil. The voltage correction coefficient map defines the relationship between the power supply voltage VB of the ignition device and the voltage correction coefficient. The request setting unit 812 determines the map energization amount according to the rotation speed NE using the request dwell map, and determines the voltage correction coefficient according to the power supply voltage using the voltage correction coefficient map. Then, the request setting unit 812 calculates the request energization amount by multiplying the map energization amount by the voltage correction coefficient. The adjustment unit 813 determines the limit energization amount according to the rotation speed NE and the ignition coil temperature TC using the limit dwell map. Then, in a case where the request energization amount is equal to or less than the limit energization amount, the adjustment unit 813 sets the ignition coil energization time (the energization amount of the ignition coil) on the basis of the request energization amount. On the other hand, when the request energization amount is larger than the limit energization amount, the ignition coil energization time is set on the basis of the limit energization amount.

As a result, the ignition coil energization time can be easily adjusted according to the ignition coil temperature TC and the request energization amount.
(3) The ROM 60 (storage unit) according to the third embodiment described above stores the request dwell map, the voltage correction coefficient map, and the temperature correction coefficient map. The request dwell map defines the relationship between the rotation speed NE and the map energization amount. The voltage correction coefficient map defines the relationship between the power supply voltage VB of the ignition device and the voltage correction coefficient. The temperature correction coefficient map defines the relationship between the ignition coil temperature TC (temperature related to the ignition device) and the temperature correction coefficient. The request setting unit 812 determines the map energization amount according to the rotation speed NE using the request dwell map. The voltage correction coefficient corresponding to the power supply voltage VB is determined using the voltage correction coefficient map, and the temperature correction coefficient corresponding to the ignition coil temperature TC is determined using the temperature correction coefficient map. Then, the adjustment unit 813 calculates the ignition coil energization time (the energization amount of the ignition coil) by multiplying the map energization amount by the voltage correction coefficient and the temperature correction coefficient.

As a result, the ignition coil energization time can be easily adjusted according to the ignition coil temperature TC and the request energization amount.
(4) The ROM 60 (storage unit) according to the fourth embodiment described above stores the low-temperature request dwell map, the high-temperature request dwell map, and the voltage correction coefficient map. The low-temperature request dwell map defines the relationship between the rotation speed and the low-temperature map energization amount. The high-temperature request dwell map defines the relationship between the rotation speed and the high-temperature map energization amount. The voltage correction coefficient map defines the relationship between the power supply voltage VB of the ignition device and the voltage correction coefficient. The request setting unit 812 determines the low-temperature map energization time corresponding to the rotation speed NE using the low-temperature request dwell map, and determines the high-temperature map energization time corresponding to the rotation speed NE using the high-temperature request dwell map. The adjustment unit 813 sets the ignition coil energization time (energization amount of the ignition coil) on the basis of the low-temperature map energization time and the high-temperature map energization time according to the ignition coil temperature TC (temperature related to the ignition device).

As a result, the ignition coil energization time can be easily adjusted according to the ignition coil temperature TC and the request energization amount.
(5) The adjustment unit 813 according to the fourth embodiment described above sets the ignition coil energization time (the energization amount of the ignition coil) on the basis of the low-temperature map energization time (the low-temperature map energization amount) in a case where the ignition coil temperature TC (the temperature related to the ignition device) is smaller than a predetermined low-temperature set value. In addition, the adjustment unit 813 sets the ignition coil energization time on the basis of the high-temperature map energization time (high-temperature map energization amount) in a case where the ignition coil temperature TC is larger than a predetermined high-temperature set value higher than the low-temperature set value. Furthermore, in a case where the ignition coil temperature TC falls between the low-temperature set value and the high-temperature set value, if the ignition coil temperature TC is changing from a state of being lower than or equal to the low-temperature set value toward the high-temperature set value, the adjustment unit 813 sets the ignition coil energization time on the basis of the low-temperature map energization time. When the ignition coil temperature TC is changing from a state of being equal to or higher than the high-temperature set value toward the low-temperature set value, the ignition coil energization time is set on the basis of the high-temperature map energization time.

As a result, in a case where the ignition coil temperature TC is a value between the low-temperature set value and the high-temperature set value, the hysteresis control can be performed to set the ignition coil energization time.
(6) The ignition coil energization time (energization amount of the ignition coil) according to the above-described embodiment is a value obtained by totaling substantial energization times to the ignition coil 300 in which single ignition for each compression top dead center, ignition for 2 times for each compression and exhaust top dead center, and interruption of multiple discharge (ignition/discharge of a plurality of times) at points other than the top dead center are performed for one combustion cycle of the internal combustion engine 100.

As a result, the ignition coil energization time (the energization amount of the ignition coil) adjusted according to the ignition coil temperature TC and the request energization amount can be easily adjusted to be applied to a plurality of types of discharge (ignition) systems.
(7) The internal combustion engine according to the above-described embodiment includes the fuel injection device 134. The control device 1 (internal combustion engine control device) includes the fuel injection amount setting unit 815 that adjusts the injection amount of fuel in the fuel injection device 134 on the basis of the ignition coil temperature TC (temperature related to the ignition device). By increasing the ignition quality of the air-fuel mixture by adjusting the fuel injection amount, the request energization amount can be reduced.

As a result, the ignition coil energization time can be easily adjusted according to the ignition coil temperature TC and the request energization amount. In addition, misfire can be suppressed.
(8) The ignition coil temperature TC (temperature related to the ignition device) according to the first to fourth embodiments described above is calculated using a neural network model having at least the rotation speed NE as an explanatory variable.

As a result, the ignition coil temperature TC can be estimated with high accuracy without providing a temperature sensor that detects the temperature of the ignition coil 300. As a result, the accuracy of the ignition coil energization time to be adjusted according to the ignition coil temperature TC can be increased, and the heat balance of the ignition device can be appropriately controlled. As a result, the cost of the ignition device can be suppressed.
(9) The explanatory variables input to the neural network models according to the first to fourth embodiments described above include a parameter (the rotation speed NE, the power supply voltage VB, the ignition coil energization amount, etc.) related to heat generation of the ignition coil 300 in the ignition device and a parameter (an intake air temperature, an intake air humidity, a cooling water temperature, a cooling wind speed, and the like) related to heat balance inside and outside the ignition device.

As a result, the ignition coil temperature TC can be estimated with high accuracy.
(10) The internal combustion engine control method according to the above-described embodiment is a method of controlling the internal combustion engine 100 in which the current flowing through the ignition coil 300 of the ignition device is interrupted according to a predetermined ignition timing. In this internal combustion engine control method, the request setting unit 812 determines the request energization amount of the ignition coil 300 on the basis of the rotation speed NE of the internal combustion engine 100. Next, the adjustment unit 813 adjusts the ignition coil energization time (the energization amount of the ignition coil) according to the ignition coil temperature TC (the temperature related to the ignition device) and the request energization amount. Then, the ignition control unit 83 controls the interruption state of the ignition coil 300 according to the ignition coil energization time adjusted by the adjustment unit 813.

As a result, it is possible to appropriately control the heat balance of the ignition device, and as a result, it is possible to suppress an increase in size and cost of the ignition device.
(11) In the internal combustion engine control method according to the first embodiment described above, the ignition device temperature estimation unit 814 outputs the ignition coil temperature TC (temperature related to the ignition device) using the first neural network model having at least the rotation speed NE of the internal combustion engine 100 as an explanatory variable. The adjustment unit 813 outputs the limit energization time (limit energization amount), which is an energization amount that can be supplied to the ignition coil 300, using the second neural network model having the ignition coil temperature TC, the power supply voltage VB, and the rotation speed NE as explanatory variables. The request setting unit 812 outputs the request energization time (request energization amount) of the ignition coil 300 using the third neural network model having at least the rotation speed NE and the ignition coil temperature TC as explanatory variables. In addition, the adjustment unit 813 adjusts the ignition coil energization time (the energization amount of the ignition coil) on the basis of the limit energization time and the request energization time. Then, the ignition control unit controls the interruption state of the ignition coil 300 according to the ignition coil energization time adjusted by the adjustment unit 813.

As a result, the ignition coil temperature TC can be grasped without providing a temperature sensor that detects the temperature of the ignition coil 300. As a result, the cost of the ignition device can be suppressed. In addition, the accuracy of the ignition coil temperature TC, the limit energization time, and the request energization time can be improved, the reliability of the adjusted ignition coil energization time can be improved, and the heat balance of the ignition device can be appropriately controlled.
(12) The explanatory variable of the first neural network model or the explanatory variable of the third neural network model according to the first embodiment described above includes a parameter (the rotation speed NE, the power supply voltage VB, the Intake flow rate, etc.) related to heat generation of the ignition coil 300 in the ignition device and a parameter (an intake air temperature, an intake air humidity, a cooling water temperature, a cooling wind speed, and the like) related to heat balance inside and outside the ignition device.

As a result, the ignition coil temperature TC can be estimated with high accuracy.

The present invention is not limited to the embodiments described above and illustrated in the drawings, and various modifications can be made without departing from the gist of the invention described in the claims.

In addition, the above-described embodiments have been described in detail in order to describe the present invention in an easy-to-understand manner, and are not necessarily limited to those having all the described configurations. Further, a part of the configuration of one embodiment can be replaced with the configuration of another embodiment, and the configuration of another embodiment can be added to the configuration of one embodiment. In addition, it is possible to add, delete, and replace other configurations for a part of the configuration of each embodiment.

### REFERENCE SIGNS LIST

1 internal combustion engine control device
10 analog input unit
20 digital input unit
30 A/D converter
40 RAM
50 MPU
60 ROM
70 I/O port
80 output circuit
81 overall control unit
82 fuel injection control unit
83 ignition control unit
84 cylinder discrimination unit
85 angle information generation unit
86 rotation speed information generation unit
87 intake amount measurement unit
88 load information generation unit
89 water temperature measurement unit
90 voltage measurement unit
100 internal combustion engine
110 air cleaner
111 intake pipe
112 intake manifold
113 throttle valve
113a throttle opening degree sensor
114 flow rate sensor
115 intake air temperature sensor
120 ring gear
121 crank angle sensor
122 water temperature sensor
123 crank shaft
125 accelerator pedal
126 accelerator position sensor
130 fuel tank
131 fuel pump
132 pressure regulator
133 fuel pipe
134 fuel injection device
140 in-cylinder pressure sensor
150 cylinder
151 intake valve
152 exhaust valve
160 exhaust manifold
161 three-way catalyst
162 upstream air-fuel ratio sensor
163 downstream air-fuel ratio sensor
170 piston
200 ignition plug
210 center electrode
220 outer electrode
230 insulator
300, 301 ignition coil
310 primary coil
320 secondary coil
330 DC power supply
340 igniter
350, 360 temperature switch unit
361 temperature detection unit
500, 501 electrical circuit
811 ignition timing setting unit
812 request setting unit
813 adjustment unit
814 ignition device temperature estimation unit
815 fuel injection amount setting unit
816 fuel injection timing setting unit

1. An internal combustion engine control device that controls an internal combustion engine in which a current flowing through an ignition coil of an ignition device is interrupted according to a predetermined ignition timing, the internal combustion engine control device comprising:
a request setting unit that determines a request energization amount of the ignition coil on a basis of a rotation speed of the internal combustion engine;
an adjustment unit that adjusts an energization amount of the ignition coil according to a temperature related to the ignition device and the request energization amount; and
an ignition control unit that controls an interruption state of the ignition coil according to the energization amount of the ignition coil adjusted by the adjustment unit.

2. The internal combustion engine control device according to claim 1, further comprising a storage unit that stores a request dwell map that defines a relationship between the rotation speed and a map energization amount, and a limit dwell map that defines a relationship between a temperature related to the rotation speed and the ignition device, and a limit energization amount that is an energization amount that can be supplied to the ignition coil, wherein
the request Setting unit calculates the request energization amount according to the rotation speed using the request dwell map,
the adjustment unit determines a limit energization amount according to the rotation speed and the temperature related to the ignition device using the limit dwell map, sets the energization amount of the ignition coil on a basis of the request energization amount in a case where the request energization amount is equal to or less than the limit energization amount, and
the energization amount of the ignition coil is set on a basis of the limit energization amount in a case where the request energization amount is larger than the limit energization amount.

3. The internal combustion engine control device according to claim 1, further comprising a storage unit that stores a request dwell map that defines a relationship between the rotation speed and a map energization amount, a voltage correction coefficient map that defines a relationship between a power supply voltage of the ignition device and a voltage correction coefficient, and a temperature correction coefficient map that defines a relationship between a temperature and a temperature correction coefficient related to the ignition device, wherein
the request setting unit determines a map energization amount according to the rotation speed using the request dwell map,
determines a voltage correction coefficient according to the power supply voltage using the voltage correction coefficient map, and
determines a temperature correction coefficient according to the temperature related to the ignition device using the temperature correction coefficient map, and
the adjustment unit calculates the energization amount of the ignition coil by multiplying the map energization amount by the voltage correction coefficient and the temperature correction coefficient.

4. The internal combustion engine control device according to claim 1, further comprising a storage unit that stores a low-temperature request dwell map that defines a relationship between the rotation speed and a low-temperature map energization amount, a high-temperature request dwell map that defines a relationship between the rotation speed and a high-temperature map energization amount, and a voltage correction coefficient map that defines a relationship between a power supply voltage of the ignition device and a voltage correction coefficient, wherein
the request setting unit determines a low-temperature map energization amount according to the rotation speed using the low-temperature request dwell map, and determines a high-temperature map energization amount according to the rotation speed using the high-temperature request dwell map, and
the adjustment unit sets the energization amount of the ignition coil on a basis of a temperature related to the ignition device, the low-temperature map energization amount, and the high-temperature map energization amount.

5. The internal combustion engine control device according to claim 4, wherein the adjustment unit sets the energization amount of the ignition coil on a basis of the low-temperature map energization amount in a case where the temperature related to the ignition device is equal to or lower than a predetermined low-temperature set value, and sets the energization amount of the ignition coil on a basis of the high-temperature map energization amount in a case where the temperature related to the ignition device is equal to or higher than a predetermined high-temperature set value higher than the low-temperature set value.

6. The internal combustion engine control device according to claim 1, wherein the energization amount of the ignition coil is a value obtained by aggregating a substantial energization time to the ignition coil that is interrupted once or a plurality of times during one combustion cycle of the internal combustion engine.

7. The internal combustion engine control device according to claim 1, wherein the internal combustion engine includes a fuel injection device, and
includes a fuel injection amount setting unit that adjusts an injection amount of fuel in the fuel injection device based on the temperature related to the ignition device.

8. The internal combustion engine control device according to claim 1, wherein the temperature related to the ignition device is output using a neural network model having at least the rotation speed as an explanatory variable.

9. The internal combustion engine control device according to claim 8, wherein an explanatory variable input to the neural network model includes a parameter related to heat generation of the ignition coil in the ignition device and a parameter related to heat balance inside and outside the ignition device.

10. An internal combustion engine control method of controlling an internal combustion engine in which a current flowing through an ignition coil of an ignition device is interrupted according to a predetermined ignition timing, the method comprising:
determining, by a request setting unit, a request energization amount of the ignition coil on a basis of a rotation speed of the internal combustion engine;
adjusting, by an adjustment unit, an energization amount of the ignition coil according to a temperature related to the ignition device and the request energization amount; and
controlling, by an ignition control unit, an interruption state of the ignition coil according to the energization amount of the ignition coil adjusted by the adjustment unit.

11. An internal combustion engine control method of controlling an internal combustion engine in which a current flowing through an ignition coil of an ignition device is interrupted according to a predetermined ignition timing, the method comprising:
outputting, by an ignition device temperature estimation unit, a temperature related to the ignition device using a first neural network model having at least a power supply voltage of the ignition device and a rotation speed of the internal combustion engine as explanatory variables;
outputting, by an adjustment unit, a limit energization amount that is an energization amount that can be supplied to the ignition coil using a second neural network model having the temperature related to the ignition device, the power supply voltage, and the rotation speed as explanatory variables;
outputting, by a request setting unit, a request energization amount of the ignition coil using a third neural network model having at least the rotation speed and the temperature related to the ignition device as explanatory variables;
adjusting, by the adjustment unit, an energization amount of the ignition coil on a basis of the limit energization amount and the request energization amount; and
controlling, by an ignition control unit, an interruption state of the ignition coil according to the energization amount of the ignition coil adjusted by the adjustment unit.

12. The internal combustion engine control method according to claim 11, wherein the explanatory variable of the first neural network model or the explanatory variable of the third neural network model includes a parameter related to heat generation of the ignition coil in the ignition device and a parameter related to heat balance inside and outside the ignition device.
